(19) United States
(12) Patent Application Publication
(10) Pub. No.: US 2026/0189420 A1
(43) Pub. Date: Jul. 2, 2026

(54) Access Controls Associated With Ingesting Multimedia Data During A Conference

(71) Applicant: Zoom Communications, Inc., San Jose, CA (US)

(72) Inventors: Brendan James Ittelson, San Jose, CA (US); Arun Janakiraman, San Francisco, CA (US); Yi Ke, Santa Clara, CA (US); Kwon Woong Oh, Mukilteo, WA (US)

(21) Appl. No.: 19/382,754

(22) Filed: Nov. 7, 2025

Related U.S. Application Data
(60) Provisional application No. 63/740,931, filed on Dec. 31, 2024.

(51) Int. Cl. H04L 12/18; G06F 3/0482; G06F 3/14; G06F 9/451; G06F 21/62; H04L 65/1093; H04L 65/403

(52) U.S. Cl. CPC H04L 12/1822; G06F 3/0482; G06F 9/451; G06F 21/629; H04L 65/1093; H04L 65/403; G06F 3/1454

(57) ABSTRACT

A conferencing server receives, from a first client device, an indication of an ingestion server associated with an integration application. The conferencing server transmits application content to a second client device to render a graphical user interface comprising a representation of the integration application and interactive access controls. The conferencing server receives an indication of a user interaction with an interactive access control corresponding to an access parameter. A value of the access parameter is established based on the user interaction. The conferencing server receives a request to connect the ingestion server to a conference, the request comprising an identifier of the ingestion server. The conferencing server establishes a communication connection with the ingestion server based on the value of the access parameter.

### CROSS REFERENCE TO RELATED APPLICATIONS

This application claims the benefit of U.S. Provisional Patent Application Ser. No. 63/740,931, filed Dec. 31, 2024, the entire disclosure of which is incorporated herein by reference.

### FIELD

This disclosure generally relates to online conferencing, and, more specifically, to access controls associated with access controls for ingestion, by an artificial intelligence engine or another data processing engine, of multimedia data during a communication session.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a conferencing system for delivering conferencing software services in an electronic computing and communications system.

FIG. 5 is a block diagram of an example of a system for ingesting multimedia data during a communication session.

FIG. 6 is a first data flow diagram of ingesting multimedia data during a communication session.

FIG. 7 is a second data flow diagram of ingesting multimedia data during a communication session.

FIG. 8 illustrates a first graphical user interface associated with access controls for ingestion of multimedia during a communication session.

FIG. 9 illustrates a second graphical user interface associated with access controls for ingestion of multimedia during a communication session.

FIG. 10 illustrates a third graphical user interface associated with access controls for ingestion of multimedia during a communication session.

FIG. 11 illustrates a third graphical user interface associated with access controls for ingestion of multimedia during a communication session.

FIG. 12 illustrates a third graphical user interface associated with access controls for ingestion of multimedia during a communication session.

FIG. 13 illustrates a third graphical user interface associated with access controls for ingestion of multimedia during a communication session.

FIG. 14 illustrates a third graphical user interface associated with access controls for ingestion of multimedia during a communication session.

FIG. 15 is a flowchart of an example of a technique associated with access controls for ingestion of multimedia during a communication session.

### DETAILED DESCRIPTION

Conferencing software is frequently used across various industries to support video-enabled conferences between participants in multiple locations. In some cases, each of the conference participants separately connects to the conferencing software from their own remote locations. In other cases, one or more of the conference participants may be physically located in and connect to the conferencing software from a conference room or similar physical space (e.g., in an office setting) while other conference participants connect to the conferencing software from one or more remote locations. Conferencing software thus enables people to conduct video conferences without requiring them to be physically present with one another. Conferencing software may be available as a standalone software product or it may be integrated within a software platform, such as a unified communications as a service (UCaaS) platform.

In the context of video conferencing, the data generated during conferences, such as audio, camera-generated video, screensharing video, and chat logs, is often merged and lacks structure. This unstructured nature of conference content creates difficulties for developers aiming to electronically process the content, using artificial intelligence (AI), machine learning (ML), or other techniques. Additionally, the lack of granular access to conference data (e.g., speaker identification or participant-specific content), increases the complexity of data processing and escalates the cost of deriving actionable insights, resulting in inefficiencies that impede innovation in AI-driven applications for industries like healthcare, legal, and finance.

AI and ML applications may be integrated to enhance productivity, streamline workflows, and derive insights from conference data. However, current methods for accessing and processing conference content may present challenges for developers and end-users.

A challenge may arise from the unstructured and merged nature of conference data, which can include audio, video, screen sharing content, and chat logs. This lack of structure and granularity may make it difficult for developers to extract meaningful insights and implement AI/ML workflows efficiently. Additionally, the absence of certain metadata, such as speaker identification or participant-specific content, may further complicate the processing of conference data, potentially increasing the complexity and costs associated with deriving actionable insights.

Some existing solutions may utilize “participant bots” that join conferences as virtual participants to ingest audio, video, and other data. However, this approach may introduce new issues, such as making human participants uncomfortable due to the presence of unknown entities in their meetings. Furthermore, the lack of granular access controls for these bots may raise privacy and security concerns, as participants may have limited ability to manage the bot's access to sensitive information shared during the conference. These challenges may impact innovation in AI-driven applications across various industries, including healthcare, legal, and finance, where efficient and secure processing of conference data may be particularly important.

Implementations of this disclosure address problems such as these by providing for securely ingesting multimedia data during a conference while maintaining user control and transparency. A conferencing server receives an indication of an ingestion server associated with an integration application from a first client device, transmits application content to a second client device to render a graphical user interface with interactive access controls, and establishes a communication connection with the ingestion server based on user interactions with these controls. This approach allows for granular access management, enhances privacy and security by providing clear disclosures to participants, and simplifies the integration of AI/ML applications with conference data while minimizing the disruptiveness of participant bots. The system also supports role-based controls and customizable administrative settings, addressing the challenges of unstructured data processing and lack of granular access controls in existing solutions.

At the beginning of a conference, when a client device connects to a conference, the client device may provide the conferencing server with a request to connect the ingestion server to the conference. The request may include an identifier of the ingestion server, and a token for authenticating the ingestion server to have access permissions to the conference based on the access permissions of the client device. As used herein, the term “token” may include, among other things, any data item (or set of data items) that is used to authenticate a machine and to determine access permissions to a dataset (e.g., of conference data) by the machine. A token may include, for example and without limitation, a signature, an entry in an access list, or other authentication data. The conferencing server may establish a communication connection with the ingestion server, using the token to determine the access permissions of the ingestion server to the conference. For example, if the user of the client device is not permitted to access a transcript or captions, the ingestion server, similarly, may not be permitted to access the transcript or captions. If the user leaves the conference, the ingestion server may also be disconnected from the conference.

In some aspects, prior to establishing the connection with the ingestion server, the conferencing server may transmit application content to other client devices connected to the conference to render graphical user interfaces (GUIs) with interactive access controls. These GUIs may include various elements such as a video portion displaying conference participants, an access control portion showing applications requesting or having access to the conference, and interactive controls for approving, denying, or disabling application access. The GUIs may also include notification panels informing participants about applications accessing meeting content, participant panels displaying user and application representations, and administrative settings panels for configuring application access at an account or organizational level. These interfaces may provide users with visibility into which applications are accessing conference data and what types of data they can access, enhancing transparency and user control.

The implementation of these access control GUIs may offer several technical advantages. By providing granular, role-based controls, the system may enhance security and privacy by allowing hosts and participants to manage application access in real-time. The clear disclosures and intuitive controls may improve user trust and adoption of AI/ML applications in conferencing environments. Additionally, the system's ability to associate applications with specific participants and display this information in the GUI may simplify troubleshooting and management of application access. The administrative settings may allow for centralized control and policy enforcement across an organization, potentially reducing security risks and ensuring compliance with data protection regulations. This approach may strike a balance between enabling innovative AI/ML applications and maintaining user control and transparency in conference environments.

In some examples of the present disclosure, implementations may include or otherwise use one or more artificial intelligence or machine learning (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

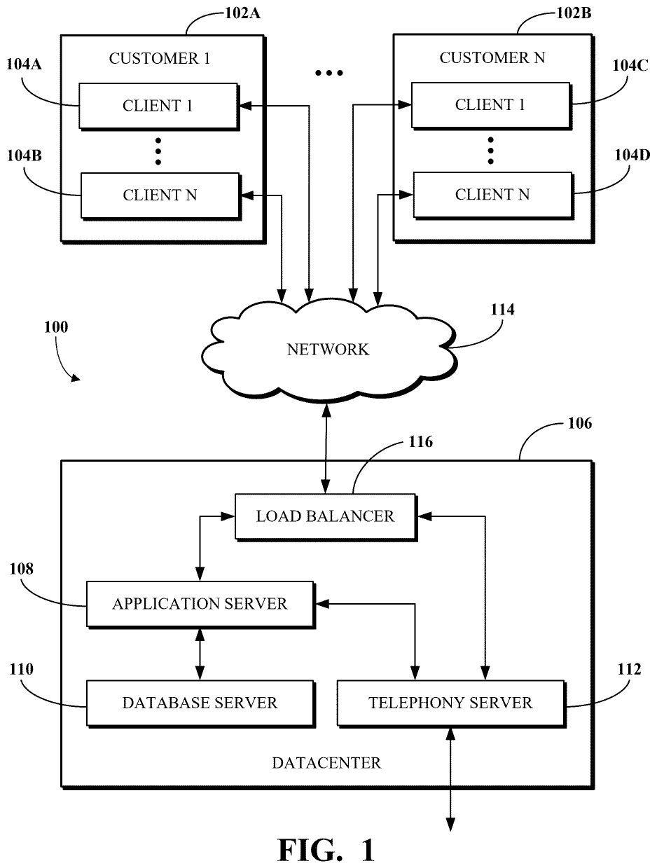

To describe some implementations in greater detail, reference is first made to examples of hardware and software structures used to implement a system for ingesting multimedia data during a communication session. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customer 102A through customer 102B, which may each be a public entity, private entity, or another corporate entity or individual that purchases or otherwise uses software services, such as of a UCaaS platform provider. Each customer can include one or more clients. For example, as shown and without limitation, the customer 102A can include a client 104A through a client 104B, and the customer 102B can include a client 104C through a client 104D. A customer can include a customer network or domain. For example, and without limitation, the client 104A through the client 104B can be associated or communicate with a customer network or domain for the customer 102A and the client 104C through the client 104D can be associated or communicate with a customer network or domain for the customer 102B.

A client, such as one of the client 104A through the client 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customer 102A through the customer 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customer 102A through the customer 102B.

In some implementations, one or more of the application server 108, the database server 110, and the telephony server 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the application server 108, the database server 110, and the telephony server 112, for example, a media server, a proxy server, or a web server.

The application server 108 runs web-based software services deliverable to a client, such as one of the client 104A through the client 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the client 104A through the client 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the client 104A through the client 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104A or the application server 108.

The telephony server 112 enables network-based telephony and web communications from and/or to clients of a customer, such as the client 104A through the client 104B for the customer 102A or the client 104C through the client 104D for the customer 102B. For example, one or more of the client 104A through the client 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the client 104A through the client 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The client 104A through the client 104D communicate with the application server 108, the database server 110, and the telephony server 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the client 104A through the client 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

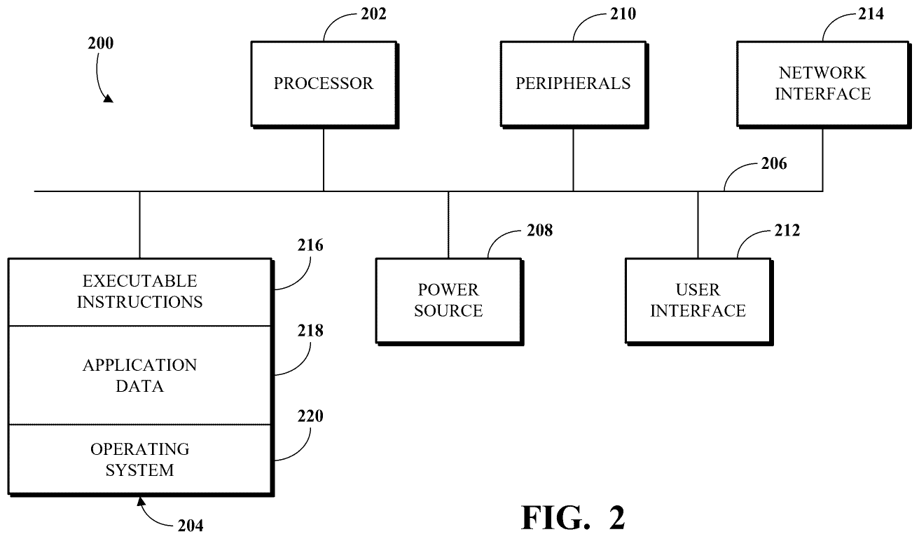

FIG. 2 is a block diagram of an example internal configuration of a computing device 200 of an electronic computing and communications system. In one configuration, the computing device 200 may implement one or more of the client 104A, the client 104B, the client 104C, the client 104D, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can

### Be a Backup Battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

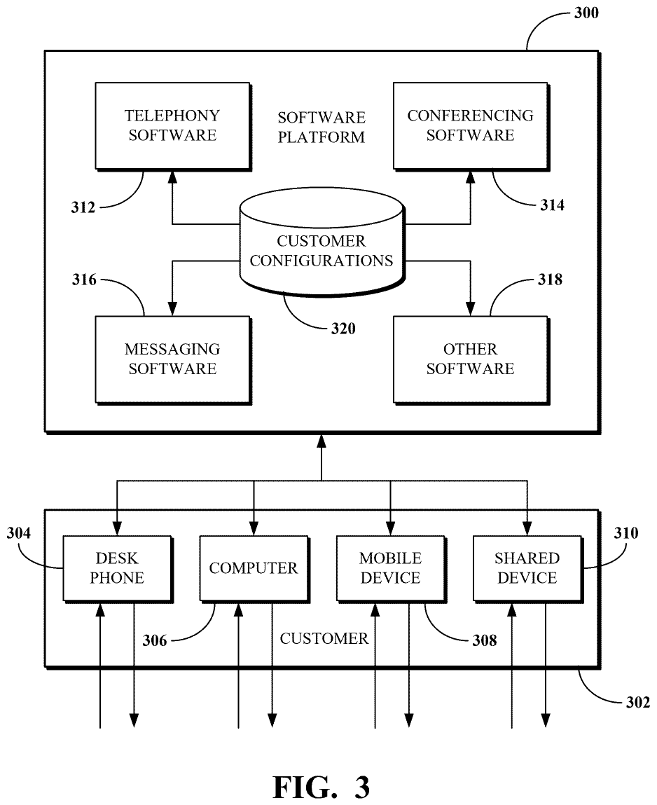

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the client 104A through the client 104B of the customer 102A or the client 104C through the client 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients: a client 304, a client 306, a client 308, and a client 310 (e.g., a desk phone, a computer, a mobile device, and a shared device, respectively). The desk phone is a desktop unit configured to at least send and receive calls and includes an input device for receiving a telephone number or extension to dial to and an output device for outputting audio and/or video for a call in progress. The computer is a desktop, laptop, or tablet computer including an input device for receiving some form of user input and an output device for outputting information in an audio and/or visual format. The mobile device is a smartphone, wearable device, or other mobile computing aspect including an input device for receiving some form of user input and an output device for outputting information in an audio and/or visual format. The desk phone, the computer, and the mobile device may generally be considered personal devices configured for use by a single user. The shared device is a desk phone, a computer, a mobile device, or a different device which may instead be configured for use by multiple specified or unspecified users.

Each of the client 304, the client 306, the client 308 and the client 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the telephony software 312, the conferencing software 314, the messaging software 316, and the other software 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the client 304, the client 306, the client 308 and the client 310 and other telephony-enabled devices, which may be other ones of the client 304, the client 306, the client 308 and the client 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, amongst the client 304, the client 306, the client 308 and the client 310 be sent or received using the desk phone, a softphone running on the computer, a mobile application running on the mobile device, or using the shared device that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for providing access controls associated with ingesting multimedia data during a communication session. In some such cases, the conferencing software 314 can include the other software 318.

The telephony software 312, the conferencing software 314, the messaging software 316, and the other software 318 may be implemented using one or more servers, for example, of a datacenter such as the datacenter 106 shown in FIG. 1. For example, one or more of the telephony software 312, the conferencing software 314, the messaging software 316, and the other software 318 may be implemented using an application server, a database server, and/or a telephony server, such as the server 108 through the server 112 shown in FIG. 1. In another example, one or more of the telephony software 312, the conferencing software 314, the messaging software 316, and the other software 318 may be implemented using servers not shown in FIG. 1, for example, a meeting server, a web server, or another server. In yet another example, one or more of the telephony software 312, the conferencing software 314, the messaging software 316, and the other software 318 may be implemented using one or more of the server 108 through the server 112 and one or more other servers. The telephony software 312, the conferencing software 314, the messaging software 316, and the other software 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the telephony software 312, the conferencing software 314, the messaging software 316, and the other software 318 may be combined into a single software application run on clients of the customer, such as one or more of the client 304, the client 306, the client 308 and the client 310.

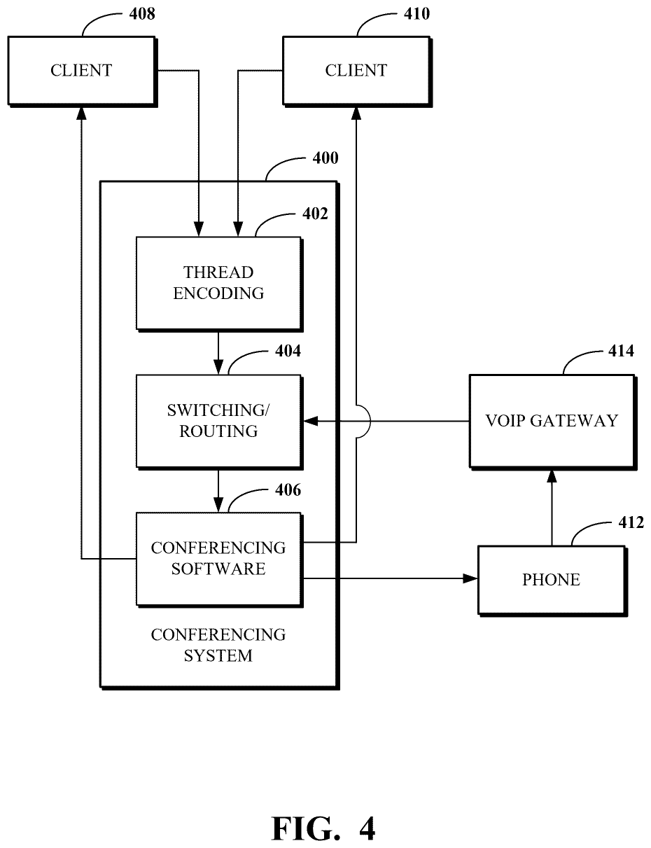

FIG. 4 is a block diagram of an example of a conferencing system 400 for delivering conferencing software services in an electronic computing and communications system, for example, the system 100 shown in FIG. 1. The conferencing system 400 includes a thread encoding tool 402, a switching/routing tool 404, and conferencing software 406. The conferencing software 406, which may, for example, the conferencing software 314 shown in FIG. 3, is software for implementing conferences (e.g., video conferences) between users of clients and/or phones, such as clients 408 and 410 and phone 412. For example, the clients 408 or 410 may each be one of the clients 304 through 310 shown in FIG. 3 that runs a client application associated with the conferencing software 406, and the phone 412 may be a telephone which does not run a client application associated with the conferencing software 406 or otherwise access a web application associated with the conferencing software 406. The conferencing system 400 may in at least some cases be implemented using one or more servers of the system 100, for example, the application server 108 shown in FIG. 1. Although two clients and a phone are shown in FIG. 4, other numbers of clients and/or other numbers of phones can connect to the conferencing system 400.

Implementing a conference (referred to herein, interchangeably, as a “communication session”) includes transmitting and receiving video, audio, and/or other data between clients and/or phones, as applicable, of the conference participants. Each of the client 408, the client 410, and the phone 412 may connect through the conferencing system 400 using separate input streams to enable users thereof to participate in a conference together using the conferencing software 406. The various channels used for establishing connections between the clients 408 and 410 and the phone 412 may, for example, be based on the individual device capabilities of the clients 408 and 410 and the phone 412.

The conferencing software 406 includes a user interface tile for each input stream received and processed at the conferencing system 400. A user interface tile as used herein generally refers to a portion of a conferencing software user interface which displays information (e.g., a rendered video) associated with one or more conference participants. A user interface tile may, but need not, be generally rectangular. The size of a user interface tile may depend on one or more factors including the view style set for the conferencing software user interface at a given time and whether the one or more conference participants represented by the user interface tile are active speakers at a given time. The view style for the conferencing software user interface, which may be uniformly configured for all conference participants by a host of the subject conference or which may be individually configured by each conference participant, may be one of a gallery view in which all user interface tiles are similarly or identically sized and arranged in a generally grid layout or a speaker view in which one or more user interface tiles for active speakers are enlarged and arranged in a center position of the conferencing software user interface while the user interface tiles for other conference participants are reduced in size and arranged near an edge of the conferencing software user interface. In some cases, the view style or one or more other configurations related to the display of user interface tiles may be based on a type of video conference implemented using the conferencing software 406 (e.g., a participant-to-participant video conference, a contact center engagement video conference, or an online learning video conference, as will be described below).

The content of the user interface tile associated with a given participant may be dependent upon the source of the input stream for that participant. For example, where a participant accesses the conferencing software 406 from a client, such as the client 408 or 410, the user interface tile associated with that participant may include a video stream captured at the client and transmitted to the conferencing system 400, which is then transmitted from the conferencing system 400 to other clients for viewing by other participants (although the participant may optionally disable video features to suspend the video stream from being presented during some or all of the conference). In another example, where a participant access the conferencing software 406 from a phone, such as the phone 412, the user interface tile for the participant may be limited to a static image showing text (e.g., a name, telephone number, or other identifier associated with the participant or the phone 412) or other default background aspect since there is no video stream presented for that participant.

The thread encoding tool 402 receives video streams separately from the clients 408 and 410 and encodes those video streams using one or more transcoding tools, such as to produce variant streams at different resolutions. For example, a given video stream received from a client may be processed using multi-stream capabilities of the conferencing system 400 to result in multiple resolution versions of that video stream, including versions at 90p, 180p, 360p, 720p, and/or 1080p, amongst others. The video streams may be received from the clients over a network, for example, the network 114 shown in FIG. 1, or by a direct wired connection, such as using a universal serial bus (USB) connection or like coupling aspect. After the video streams are encoded, the switching/routing tool 404 direct the encoded streams through applicable network infrastructure and/or other hardware to deliver the encoded streams to the conferencing software 406. The conferencing software 406 transmits the encoded video streams to each connected client, such as the clients 408 and 410, which receive and decode the encoded video streams to output the video content thereof for display by video output components of the clients, such as within respective user interface tiles of a user interface of the conferencing software 406.

A user of the phone 412 participates in a conference using an audio-only connection and may be referred to an audio-only caller. To participate in the conference from the phone 412, an audio signal from the phone 412 is received and processed at a VOIP gateway 414 to prepare a digital telephony signal for processing at the conferencing system 400. The VOIP gateway 414 may be part of the system 100, for example, implemented at or in connection with a server of the datacenter 106, such as the telephony server 112 shown in FIG. 1. Alternatively, the VOIP gateway 414 may be located on the user-side, such as in a same location as the phone 412. The digital telephony signal is a packet switched signal transmitted to the switching/routing tool 404 for delivery to the conferencing software 406. The conferencing software 406 outputs an audio signal representing a combined audio capture for each participant of the conference for output by an audio output component of the phone 412. In some implementations, the VOIP gateway 414 may be omitted, for example, where the phone 412 is a VOIP-enabled phone.

A conference implemented using the conferencing software 406 may be referred to as a video conference in which video streaming is enabled for the conference participants thereof. The enabling of video streaming for a conference participant of a video conference does not require that the conference participant activate or otherwise use video functionality for participating in the video conference. For example, a conference may still be a video conference where none of the participants joining using clients turns on their video stream for any portion of the conference. In some cases, however, the conference may have video disabled, such as where each participant connects to the conference using a phone rather than a client, or where a host of the conference selectively configures the conference to exclude video functionality.

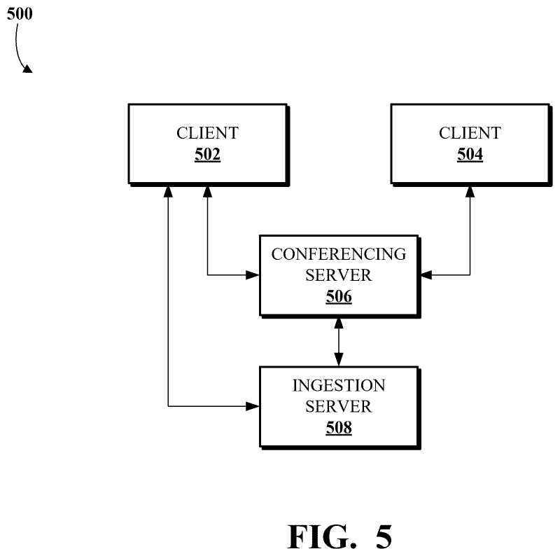

FIG. 5 is a block diagram of an example of a system 500 for ingesting multimedia data during a conference. As shown, the system 500 includes clients 502, 504, a conferencing server 506, and an ingestion server 508. The clients 502, 504 may, for example, correspond to the clients 408, 410. The conferencing server 506 may, for example, be a server of the conferencing system 400 and may include at least one of the thread encoding tool 402, the switching/routing tool 404, or the conferencing software 406. As shown, the ingestion server 508 is connected to the client 502 and may be associated with an organization (e.g., a business) of the client 502 (e.g., an employer of a user of the client 502).

As illustrated, the clients 502, 504 connect to the conferencing server 506 and engage in a conference (e.g., a multimedia conference or a contact center engagement) via the conferencing server 506. The conferencing server 506 receives, from the client 502, a request a request to connect the ingestion server 508 to the conference. The request includes a token for authentication of the ingestion server 508 and an identifier of the ingestion server 508. The token may include an identifier of the client 502 or an account associated with the client 502. The token may specify permissions of the client 502 with respect to the conference (e.g., whether the client 502 has permissions to record visual data or audio data). Alternatively, the token may include a link to an entry in a data repository (e.g., a database) that specifies the permissions. The user of the client 502 may generate the request to connect the ingestion server 508 to the conference in order to execute software (e.g., AI/ML software) stored at the ingestion server 508 on data transmitted during the conference. For example, the ingestion server 508 may include at least one of summarization software, translation software, transcription software, note taking software, or task list generation software. The software stored at the ingestion server 508 may be performed using AI models of the ingestion server 508. The AI models may include at least one of a large language model (LLM), a convolutional neural network (CNN), or another type of AI model.

The conferencing server 506 establishes a communication connection with the ingestion server 508 based on the token. As a result, the ingestion server 508 accesses the conference with access permissions corresponding to those of the client 502. For example, if the client 502 lacks permission to record the conference, the ingestion server 508 would also lack permissions to record the conference.

During the conference, the conferencing server 506 transmits, to the ingestion server 508, at least a portion of the multimedia data of the conference using the established communication connection. The multimedia data that is transmitted via the established communication connection is selected based on the token.

The multimedia data transmitted to the ingestion server 508 may include video streams, audio streams, or other data shared during the conference, such as screen sharing content or chat logs. The ingestion server 508 processes this data to perform one or more tasks specified by the client 502, leveraging its AI/ML capabilities. For example, the ingestion server 508 may process the audio data using speech-to-text technology and generate a real-time transcription of the conference. Additionally, the ingestion server 508 may analyze video streams using computer vision algorithms to identify participants, track their engagement, or detect specific gestures. The processed outputs may be returned to the client 502 or made available for retrieval by other authorized systems, thereby enhancing the conference experience of the user of the client 502.

Furthermore, the ingestion server 508 may support advanced workflows by integrating with other enterprise systems or databases associated with the organization of the client 502. For instance, if the ingestion server 508 generates a task list based on the conference discussion, it could automatically synchronize the task list with a project management tool or send notifications to relevant team members. Similarly, summarization software at the ingestion server 508 might produce condensed meeting summaries that are stored in a knowledge management system for future reference. These functionalities highlight the ability of the ingestion server 508 to act not only as a data processor but also as an enabler of seamless collaboration and productivity.

To maintain security and ensure compliance with data protection regulations, the system 500 implements various safeguards during data transmission and processing. The established communication connection between the conferencing server 506 and the ingestion server 508 is encrypted to prevent unauthorized access to sensitive conference data. Additionally, the ingestion server 508 logs all data access and processing activities for audit purposes, enabling the organization of the client 502 to monitor and verify compliance. These security measures ensure that the system 500 can be deployed in a wide range of applications, including those having stringent privacy and confidentiality standards, such as medical communications or financial communications.

In some implementations, the client 504 may not communicate directly with the ingestion server 506. For example, the client 504 may be associated with an organization that is different from an organization managing the ingestion server 508. In such implementations, the ingestion server 508 may still receive audio or visual data from that is transmitted by the client 504 to the conference via the conferencing server 506.

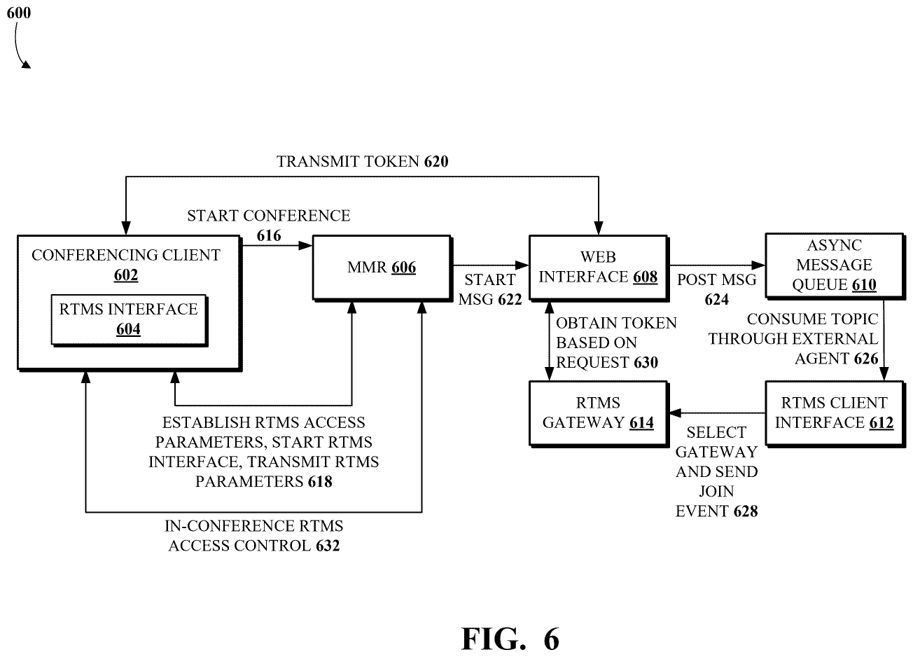

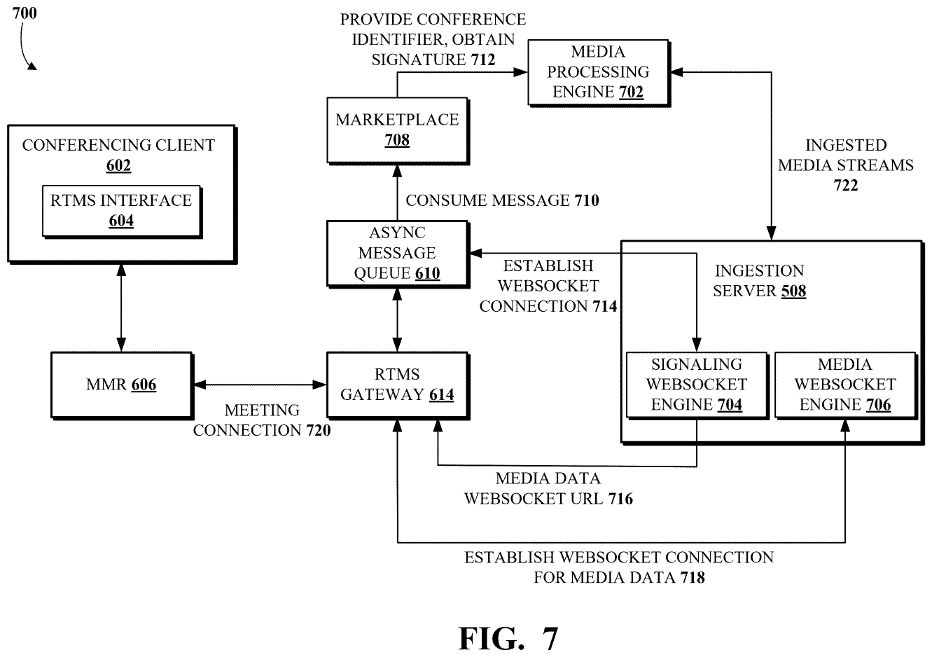

FIGS. 6-7 pertain to a process flow of establishing a real-time media stream (RTMS) during a conference. It outlines a sequence of steps that take place between various components, including the meeting client, RTMS gateway (GW), media WebSocket servers, and signaling WebSocket servers.

A problem addressed by some implementations is the need to efficiently and securely establish real-time media streams (such as audio and potentially video) during a conference. A challenge arises in coordinating the communication between the meeting client and various backend servers in a way that ensures secure data transmission, low latency, and reliable streaming of media content (e.g., mixed audio data).

The solution proposed in FIGS. 6-7 is a systematic technique for setting up and managing the connections necessary to stream media in real time during a conference. The process flow is designed to ensure that appropriate meeting tokens, WebSocket connections, and signatures are used to authenticate and establish media streams, while keeping signaling and media data channels separate. Additionally, the solution is scalable, allowing a WebSocket servers to either be located on the same machine or distributed across different systems, depending on the load or architecture preferences.

FIG. 6 is a data flow diagram 600 of ingesting multimedia data during a conference. As shown, the data flow diagram 600 includes a conferencing client 602, which includes a RTMS interface 604. The conferencing client 602 may correspond to the client 502. The data flow diagram 600 includes a meeting management router (MMR) 606, a web interface 608, an asynchronous (async) message queue 610, a RTMS client interface 612, and a RTMS gateway 614. The MMR 606, the web interface 608, the async message queue 610, the RTMS client interface 612, and the RTMS gateway 614 may reside at the conferencing server 506. The conferencing server 506 facilitates real-time communication and interaction between multiple conferencing clients by managing multimedia data streams, access permissions, and data routing.

The web interface 608 operates as a component within the conferencing server architecture, enabling the initiation and management of multimedia data ingestion during a conference. Specifically, the web interface 608 functions to receive and process start messages transmitted by the MMR 606, subsequently facilitating the transmission of relevant instructions and conference data to downstream components, such as the asynchronous message queue 610. The web interface 608 plays a role in ensuring the seamless routing of data streams, as it manages the interaction between the conferencing client 602 and the RTMS infrastructure, thereby supporting the efficient delivery of audio, video, and metadata to connected entities, for example, the ingestion server 508.

At 616, the conferencing client 602 transmits, to the MMR 606, a signal to start a conference. This signal may include initialization parameters such as session identifiers, authentication credentials, and requested media types (e.g., audio, video, or both).

At 618, the conferencing client 602 and the MMR 606 establish access parameters associated with the RTMS interface 604. In some implementations, this step may involve presenting interactive access controls to a host of the conference through a graphical user interface rendered on a display device of the host's client device. These interactive access controls may allow the host to manage and configure access permissions for integration applications hosted by ingestion servers that request connection to the conference. The graphical user interface may include representations of the integration applications, along with information about the types of multimedia data they can access, such as audio, video, transcripts, chat logs, or screen sharing content. The host may interact with these controls to approve, deny, or modify access permissions for each integration application.

In some implementations, the access parameters established during this step may include various access modes, such as an enabled access mode, a disabled access mode, or an approval-required access mode. The host may select an appropriate access mode for each integration application through interactive toggles or dropdown menus within the graphical user interface. Additionally, the interface may provide options for setting global permissions that apply to all integration applications, or for configuring application-specific settings. For example, the host may choose to enable automatic connection for certain trusted applications, while requiring manual approval for others. In some implementations, the access controls may also allow the host to specify which types of multimedia data each integration application can access, providing granular control over data sharing during the conference.

In some implementations, the establishment of access parameters may involve role-based controls, where the available options and permissions are determined based on the participant type of the user setting the parameters. For instance, a conference organizer may have more extensive control options compared to a regular participant. The system may also support administrative settings that allow organization-wide policies to be applied, such as always-on modes for certain applications or restrictions on specific data types. In some cases, the graphical user interface may include a participant panel that displays both human participants and connected integration applications, allowing the host to manage access permissions directly from this unified view. The interface may provide notifications about applications requesting access and allow the host to view detailed information about each application's data usage and processing activities.

At 618, the conferencing client also transmits, to the MMR 606, a signal to start an RTMS interface 604. At 616, the conferencing client 602 also transmits RTMS parameters to the MMR 606, which may include encoding formats, bitrates, and network protocol preferences to optimize the data flow for the conference environment.

At 620, the conferencing client 602 transmits a token representing permissions or settings for an ingestion server (e.g., the ingestion server 508 shown in FIG. 5) to access the conference. The permissions may be determined based on a video conferencing account of the user of the conferencing client 602. The settings may be determined based on an application executing on the ingestion server. For example, a summarization application executing on the ingestion server (that generates a summary of the conference) may have different settings from a translation application executing on the ingestion server (that translates the conference from one natural language to another). The token may include metadata such as time-stamped permissions, allowed data types (e.g., video or audio), and specific ingestion server capabilities.

At 622, the MMR 606 transmits a start message to the web interface 608, causing conference data transmission to the ingestion server to start. This start message may include a session identifier and an encryption key for secure data transmission.

At 624, the web interface 608 transmits a post message to the async message queue 610. The post message includes instructions for routing conference data and may include payloads such as media packet headers, participant information, and topic classifications.

At 626, the async message queue 610 consumes a topic through an external agent and sends the consumed topic to the RTMS client interface 612. The topic may correspond to a subset of the multimedia data of the conference, identified based on the token, that is to be transmitted to the ingestion server. For instance, the topic may specify video data streams for a particular participant or sections of the audio relevant to specific meeting agenda items.

At 628, the RTMS client interface 612 selects a gateway and sends a join event for the ingestion server to join the conference (e.g., receive data from the conference). The gateway selection process may involve evaluating network latency, bandwidth availability, and geographic proximity to optimize performance.

At 630, the RTMS gateway 614 requests a token from the web interface 608 and obtains the token based on the request. The token retrieval process ensures compliance with the session's security protocols, verifying the permissions and session validity before granting access.

At 632, in-conference RTMS access control may be facilitated by the MMR 606 and the conferencing client 602 (and/or the RTMS interface 604). During this step, interactive access controls for managing continued access to the conference by integration applications hosted by ingestion servers, as well as handling newly requested access, may be presented to a host of the conference. These controls may be displayed through a graphical user interface on the host's client device, allowing real-time management of application access throughout the conference duration. The interface may include a list of currently connected applications, their access status, or the types of data they are permitted to access. For newly requested access, the host may be presented with approval prompts that provide details about the requesting application and its intended use of conference data.

In some implementations, the access controls may offer granular permissions management, allowing the host to modify access parameters for individual applications or groups of applications. For example, the host may be able to revoke access to video streams for a particular application while maintaining its access to audio and transcript data. The interface may provide options for setting time-based access restrictions, such as granting an application access for only a portion of the conference or scheduling access to begin at a specific time during the session. In some implementations, the system may support role-based access control, where different participants may have varying levels of authority to manage application access based on their assigned roles within the conference.

In some implementations, the access control interface may include a dashboard that displays real-time analytics on data usage by connected applications. This dashboard may show metrics such as data volume accessed, processing time, and any potential performance impacts on the conference. The system may incorporate machine learning algorithms to suggest access control decisions based on historical patterns and predefined security policies. For example, if an application consistently accesses sensitive data during confidential portions of meetings, the system may prompt the host to restrict its access during similar segments in future conferences. In some implementations, the access control mechanism may support integration with external identity and access management systems, allowing organizations to enforce company-wide policies and compliance requirements for third-party application access during conferences.

FIG. 7 is a data flow diagram 700 of ingesting multimedia data during a conference. The data flow diagram 700 may be executed together with the data flow diagram 600, for example, the operations in the data flow diagram 700 may be executed after, before, or in parallel with the operations in the data flow diagram 600. As shown, the data flow diagram 700 includes the conferencing client 602, the RTMS interface 604, the MMR 606, the async message queue 610, and the RTMS gateway 614 of FIG. 6. The data flow diagram 700 also includes the ingestion server 508, which communicates with a media processing engine 702, a signaling WebSocket engine 704, and a media WebSocket engine 706.

The data flow diagram 700 also includes a marketplace 708. The marketplace 708 is a platform provided by the conferencing service that permits users and organizations to find and integrate third-party applications or services with the video conferencing ecosystem. Through the marketplace 708, developers may offer a wide array of applications that integrate with the conferencing service's application programming interfaces (APIs) and software development kits (SDKs). These integrations may expand the conferencing service's functionality by, for example, synchronizing data with customer relationship management systems, automating scheduling workflows, or enabling collaboration features within the conferencing interface. Developers may submit their applications to the marketplace 708 after going through a review processes. Once approved, the applications may become publicly available for download or purchase. Users or organizations that install such applications may configure the integrations to suit their particular workflows and requirements. In some instances, the applications may request permission to access user data, which may be governed by the conferencing service's security and privacy policies.

The media processing engine 702, the signaling WebSocket engine 704, and the media WebSocket engine 706 may reside on different servers of the ingestion server 508 (which may include multiple servers), or on servers independent of the ingestion server 508. Alternatively, two or more of the media processing engine 702, the signaling WebSocket engine 704, and the media WebSocket engine 706 may reside on the same server. This configuration enables scalability and flexibility in handling diverse conferencing data, optimizing load balancing across server resources.

In some implementations, the MMR 606, the async message queue 610, the RTMS gateway 614, and the marketplace 708 may be maintained by a first entity (e.g., a multimedia conferencing service provider) and the ingestion server 508 may be maintained by a second, different entity (e.g., an integration application provider). In such implementations, for example, the media processing engine and the ingestion server 508 may be considered an “app” from the perspective of the first entity. In some implementations, the MMR 606, the RTMS gateway 614, and the ingestion server 508 may all be maintained by the first entity (for example in an implementation that supports RTMS within an organization). In some implementations, the media processing engine 702 may be maintained by the first entity, the second entity, or a third entity.

The MMR 606 manages session initiation and participant coordination with respect to the conferencing client and/or additional conferencing clients. The MMR 606 also provides a connection between the conferencing client 602 and the RTMS gateway 614, thereby providing a meeting connection 716.

The media processing engine 702 may be configured to process media ingested by the ingestion server 508. For example, the media processing engine 702 may execute analysis programs such as, for example, AI/ML inferencing technology, based on multimedia data (or other data) of the conference. The multimedia data may include audio, video, and shared screen content, as well as metadata such as timestamps and speaker identification. For example, the media processing engine 702 may generate a transcript or a summary of the conference. In another example, the media processing engine 702 takes notes on behalf of the user of the conferencing client 602. For example, if the media processing engine 702 has access to information (e.g., in an employee database) indicating that the user is an accountant, the media processing engine 702 may generate detailed notes associated with discussions of taxes or accounting in the conference and may generate less detailed notes regarding other parts of the conference. Additionally, the media processing engine 702 may classify discussions by topic, identify action items, or highlight key decisions for enhanced post-meeting usability.

The signaling WebSocket engine 704 manages signaling operations, including session initiation (on the part of the ingestion server 508), participant coordination (e.g., participant coordination associated with the ingestion server 508), and real-time communication protocol exchanges. It enables the establishment and maintenance of WebSocket connections between the ingestion server 508 and other entities, such as the RTMS gateway 614. Specifically, the signaling WebSocket engine 704 handles message routing to ensure synchronization between conference participants and provides acknowledgments for communication events.

The media RTMS gateway 614 handles the real-time transmission of multimedia data streams, including encoding, decoding, and packetization processes necessary for conference media delivery. It facilitates the reception and forwarding of media data, such as audio, video, and shared content, between the RTMS gateway (e.g., associated with a first entity such as a conferencing service provider) and the ingestion server 508 (e.g., associated with a second entity external to the first entity). Additionally, the media RTMS gateway 614 may optimize media stream quality by adjusting bitrate and resolution based on network conditions. In some implementations, the MMR 606 and/or the RTMS gateway 614 may optimize media stream quality by adjusting bit rate and resolution based on network conditions or application developer preferences.

At 710, the async message queue 610 consumes a message and communicates with the marketplace 708. At 712, the marketplace 708 provides a conference identifier of the conference to the media processing engine 702. The marketplace 708 obtains a signature of the media processing engine 702 to verify the authenticity of the media processing engine 702 prior to connection of the media processing engine 702 to the conference. The conference identifier may include unique metadata such as session identifiers, participant lists, and timestamps to ensure accurate context for the operations of the media processing engine 702. The signature verification ensures secure and trusted interactions with the media processing engine 702.

At 714, the signaling WebSocket engine 704 establishes a WebSocket connection (e.g., a bidirectional WebSocket connection) with the RTMS gateway 614 via the async message queue 610. This connection involves an initial handshake protocol, wherein the signaling WebSocket engine 704 sends a connection request to the async message queue 610, which includes parameters such as a session token, encryption keys, and authentication credentials. The handshake ensures that the async message queue 610 verifies the identity of the signaling WebSocket engine 704 and authorizes its access to the conference resources. Upon successful verification, the async message queue 610 responds with an acknowledgment message, completing the connection establishment. Additionally, the signaling WebSocket engine 704 monitors the status of the WebSocket connection, periodically transmitting keep-alive messages to prevent timeouts and ensure that the communication channel remains active throughout the conference.

At 716, the signaling WebSocket engine 704 transmits a media data WebSocket uniform resource locator (URL) to the RTMS gateway 614. The URL specifies the endpoint for the media WebSocket engine 706 to facilitate the transmission of multimedia data streams. The media data WebSocket URL includes information such as the protocol type (e.g., wss:// for secure WebSocket communication), the host address, the port number, and query parameters defining the session context. For example, the URL may contain an embedded token for session authentication, a reference to the specific conference identifier, and quality-of-service (QoS) parameters that prioritize audio over video for low-bandwidth scenarios. Additionally, the signaling WebSocket engine 704 ensures that the media data WebSocket URL is encrypted before transmission to maintain data security and prevent unauthorized access.

At 718, the media WebSocket engine 706 and the RTMS gateway 614 establish a WebSocket connection (e.g., a bidirectional WebSocket connection) for media data of the conference based on the URL. This process begins with the media WebSocket engine 706 resolving the provided URL to identify the RTMS gateway 614 endpoint and initiating a connection request. The request may include headers specifying the desired media types (e.g., audio, video, or shared screen content), supported codecs (e.g., H.264 for video, Opus for audio), and network conditions such as available bandwidth. Once the connection is established, the media WebSocket engine 706 and the RTMS gateway 614 synchronize their protocols to initiate the exchange of multimedia data packets. During this exchange, the media WebSocket engine 706 implements error-checking mechanisms, such as packet retransmission for lost data and jitter buffering to ensure smooth playback. Additionally, the media WebSocket engine 706 dynamically adjusts encoding parameters, such as bitrate and resolution, based on real-time feedback from the RTMS gateway 614 to optimize the quality of the media streams under varying network conditions. Furthermore, the connection supports bi-directional communication, enabling the RTMS gateway 614 to send acknowledgments, control signals, or requests for retransmission to the media WebSocket engine 706 as necessary to maintain high data integrity.

At 720, the RTMS gateway 614 establishes a meeting connection with the MMR 606, and at 722, ingested streams and data associated therewith may be passed between the media processing engine 702 and the ingestion server 508.

Some implementations may provide various forms of notification regarding the presence of integration applications in a conference and their associated access controls. These notifications may be tailored to different types of conferences and participant access methods, ensuring that all participants are informed about the use of integration applications regardless of their mode of participation.

For audio-only participants or in audio-only conferences, the system may provide audible notifications over the conference line. For example, when an integration application joins or requests access to the conference, an automated voice message may announce, “An AI assistant application is requesting access to this conference.” This message may be followed by a brief description of the application's intended use and the types of data it may access. In some cases, the system may provide periodic reminders throughout the conference, such as “The AI transcription service is currently active in this conference.” These audible notifications may be particularly useful for participants who have joined via telephone or in situations where video conferencing is not enabled.

In addition to audible notifications, the system may employ other non-interactive notification methods. For example, in text-based chat conferences or for participants joining via chat interfaces, the system may send automated text messages to notify users about integration applications. These messages may appear in the chat window and may include details such as the name of the application, its purpose, and the types of data it can access. For email-based conference invitations, the system may include a section detailing any pre-approved integration applications that will be present in the conference, allowing participants to be informed before joining. In some implementations, the system may also send post-conference notifications to all participants, summarizing which integration applications were active during the conference and what types of data they accessed. This approach may provide transparency and allow participants to follow up if they have any concerns about data usage or privacy.

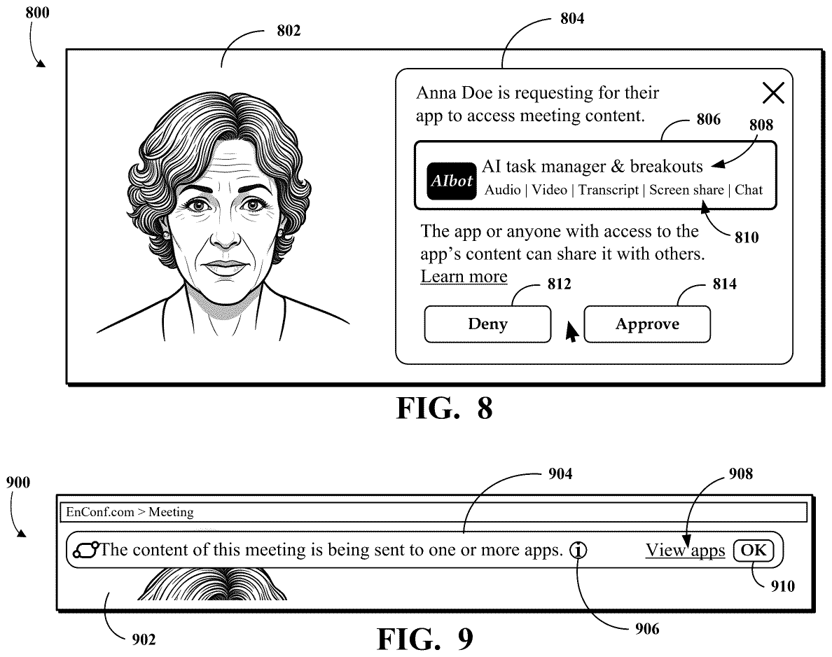

FIG. 8 illustrates a graphical user interface (GUI) 800 associated with access controls for ingestion of multimedia during a communication session. The GUI 800 may be displayed at a client device (e.g., the client 502 or the conferencing client 602) that is connected to a conference. As shown, the GUI 800 includes a video feed 802 and a control panel 804. The GUI 800 is designed to present real-time conference information in an intuitive layout, integrating video and control for enhanced user engagement.

The video feed 802 includes video imagery associated with the conference. As shown, the video feed 802 includes camera-generated data. The camera-generated data may include live video streams of conference participants captured via built-in or external webcams. In some cases, the video feed 802 may include shared screen data. The shared screen data may include documents, presentation slides, or software demonstrations shared by one or more participants during the conference. The video feed 802 may also incorporate overlays, such as participant names, speaking indicators, or real-time transcription text synchronized with the audio stream. Additionally, the video feed 802 may provide customizable options, allowing the user to switch between active speaker view, gallery view, and shared content view, depending on the user's preference.

As shown, the control panel 804 includes a representation 806 of an integration application labeled with an application name 808. The representation 806 of the integration application may be a graphical icon, logo, or text-based identifier associated with a specific integration application that is requesting or has been granted access to the conference. For example, the representation may be an icon for a note-taking application, a transcription service, or an AI-powered meeting assistant. In some implementations, the representation 806 may be customizable by the application developer or the conference host.

The application name 808 provides a textual identifier for the integration application. This may include the official name of the application, a shortened version of the name, or a user-defined alias. For example, the application name could be “AI Notetaker,” “TranscriptPro,” or “MeetingAssist.” In some implementations, the application name 808 may be accompanied by additional descriptive text, version information, a logo, or an icon, among other examples.

The control panel 804 displays supported modalities 810 indicating the types of content the application can access. These modalities may include audio, video, transcript, screen share, and chat, among others. For example, a transcription application might have access to audio and potentially video, while a note-taking application might require access to audio, transcript, and chat. In some implementations, the supported modalities 810 may be represented by icons or color-coded indicators to provide a quick visual reference for users.

Interactive access controls 812 and 814 allow users to approve or deny the application's access request. These controls may take the form of buttons, toggles, or other interactive elements. For example, control 812 might be a “Deny” button, while control 814 could be an “Approve” button. In some implementations, these controls may have additional options, such as “Approve with limitations” or “Deny and block future requests.” The interactive nature of these controls allows conference participants or hosts to manage application access in real-time during the conference.

The control panel 804 may also include additional information about the integration application, such as the user who initiated the application, the duration of access requested, or a brief description of the application's functionality. For instance, it might display “Requested by: John Doe” or “Access duration: Entire meeting.” In some implementations, this additional information may be expandable or accessible through a separate interface element.

In some implementations, the control panel 804 may include a status indicator for each integration application. This could be a colored dot or icon showing whether the application is currently active, pending approval, or denied access. For example, a green dot might indicate an active application, while a yellow dot could represent a pending request. This status indicator provides at-a-glance information about the current state of each integration application.

The control panel 804 may also feature a search or filter function to help users manage multiple integration applications. This could allow users to search for specific applications by name, filter by modality access, or sort applications based on their status. For example, a search bar might be included at the top of the control panel, or filter options could be accessible through a dropdown menu. In some implementations, this functionality may be particularly useful for conferences with numerous integration applications.

In some implementations, the control panel 804 may include a “Learn More” or “Details” button for each integration application. When selected, this button could open a modal window or side panel providing more comprehensive information about the application, its data usage policies, privacy practices, and any relevant certifications or compliance information. This additional layer of transparency can help users make informed decisions about granting access to integration applications.

FIG. 9 illustrates a GUI 900 associated with access controls for ingestion of multimedia during a communication session. The GUI 900 may be displayed at a client device (e.g., the client 502 or the conferencing client 602) that is connected to a conference. As shown, the GUI 900 includes a video feed 902 and a notification panel 904. The GUI 900 is designed to present real-time conference information in an intuitive layout, integrating video and notification insights for enhanced user engagement. As shown, the video feed 902 has functionality similar to that of the video feed 802. In addition to displaying video imagery, the video feed 902, similar to the video feed 802, may support advanced features such as background blurring, virtual backgrounds, and video quality optimization based on available network bandwidth.

The notification panel 904 serves as an informative element within the GUI 900, providing users with important updates and alerts related to the conference and integration applications. In some implementations, the notification panel 904 may include an information link 906, which when selected, may provide users with additional details about the current state of the conference or connected integration applications. The information link 906 may be implemented as a clickable text element, an icon, or a button, among other possibilities.

The notification panel 904 may also include a hyperlink 908, which can direct users to a list of integration applications that have access to the conference. In some implementations, the hyperlink 908 may open a new window or tab with detailed documentation, privacy policies, or user guides related to the integration applications currently accessing the conference data.

A confirmation button 910 may be included in the notification panel 904, allowing users to acknowledge and respond to notifications about content access. In some implementations, the confirmation button 910 may be used to grant or revoke permissions for integration applications, or to dismiss notifications after they have been read and understood by the user.

The notification panel 904 may be designed to be non-intrusive while still capturing the user's attention when necessary. In some implementations, the notification panel 904 may appear as a semi-transparent overlay that can be easily dismissed or minimized. In some implementations, it may be a persistent element of the GUI that changes color or animates to indicate new notifications.

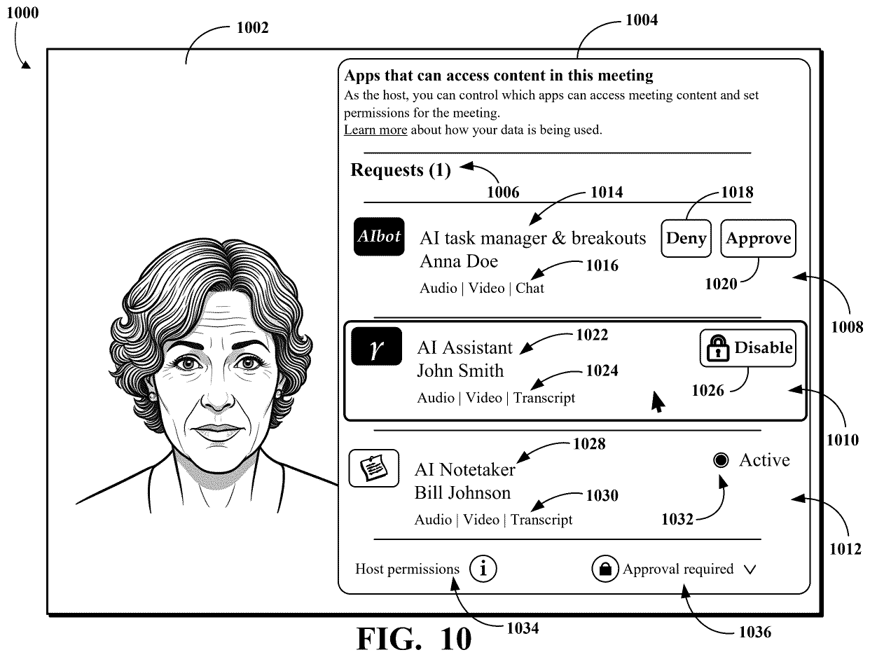

FIG. 10 illustrates a GUI 1000 associated with access controls for ingestion of multimedia during a communication session. The GUI 1000 may be displayed at a client device (e.g., the client 502 or the conferencing client 602) that is connected to a conference. Similar to the GUI 800 and the GUI 900, the GUI 1000 includes a video feed 1002 and an access control portion 1004. The video feed 1002 has a functionality similar to that of the video feed 802 and the video feed 902.

The access control portion 1004 includes a request indicator 1006, which may display text such as “Apps that can access content in this meeting.” This indicator serves to inform users about the presence and status of integration applications that have requested or been granted access to the conference data. In some implementations, the request indicator 1006 may be updated in real-time as new applications request access or as permissions change during the course of the conference.

The access control portion 1004 includes multiple user/application representations 1008, 1010, and 1012. Each representation provides information about different applications and their associated users. For example, the user/application representation 1008 shows an application name 1014 “AI task manager & breakouts” along with supported modalities 1016 indicating “Audio|Video|Chat”. This representation allows users to quickly understand which types of data each application is requesting or has been granted access to.

Interactive access controls 1018 and 1020 are provided for each user/application representation, allowing users (typically hosts or co-hosts) to manage access permissions in real-time. For instance, the controls 1018 may include “Deny” and “Approve” buttons, enabling quick decision-making about application access requests. In some implementations, these controls may be customizable, allowing for more nuanced permissions such as “Approve with limitations” or “Deny and block future requests.”

The user/application representation 1010 displays an application name 1022 “AI Assistant” with supported modalities 1024 showing “Audio|Video|Transcript”. An interactive access control 1026 labeled “Disable” is provided, allowing users to revoke access for applications that have already been approved. This granular control ensures that hosts can manage application access throughout the duration of the conference as needed.

The user/application representation 1012 shows an application name 1028 “AI Notetaker” with supported modalities 1030 indicating “Audio|Video|Transcript”. A status indicator 1032 may be included to show the current state of the application's access, such as “Active” or “Pending.”

At the bottom of the access control portion 1004, there is an interactive host permission control element 1034 and an access mode indicator 1036. These elements allow the host to manage overall permissions for applications accessing the meeting content. The host permission control element 1034 may be a dropdown menu or a set of radio buttons that allow the host to quickly change the global access policy for the conference.

In some implementations, the access control portion 1004 may include additional features such as a search function to filter applications, a sorting mechanism to organize applications by name or status, or a detailed view option that provides more comprehensive information about each application's data usage and processing activities.

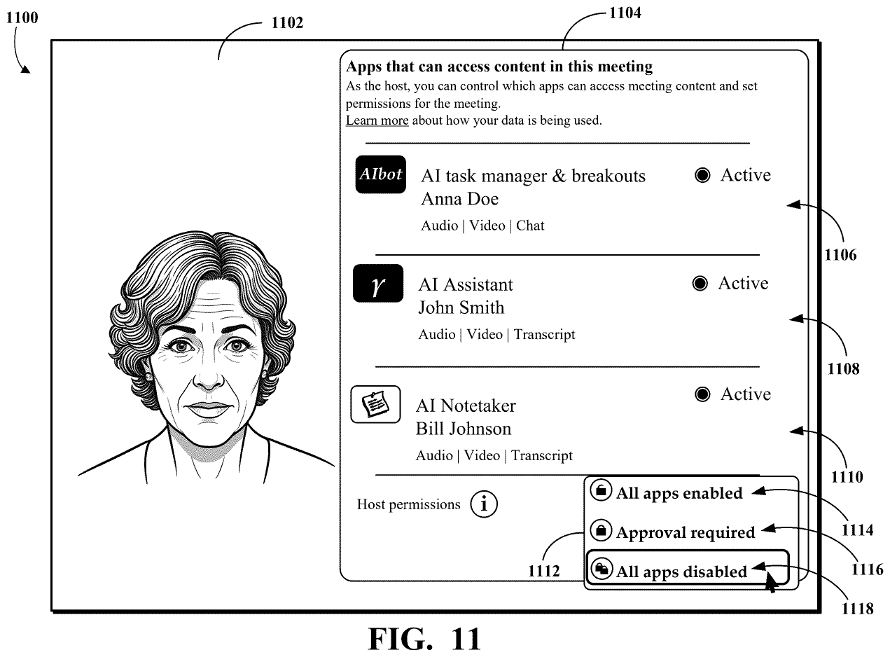

FIG. 11 illustrates a GUI 1100 associated with access controls for ingestion of multimedia during a communication session. The GUI 1100 may be displayed at a client device (e.g., the client 502 or the conferencing client 602) that is connected to a conference. Similar to the GUI 800, the GUI 900, and the GUI 1000, the GUI 1100 includes a video feed 1102 and an access control portion 1104. The video feed 1102 has a functionality similar to that of the video feed 802, the video feed 902, and the video feed 1002.

The access control portion 1104 displays multiple user/application representations 1106, 1108, and 1110, which show different applications and their current status in the conference. These representations may include information such as the application name, the associated user, and the types of data the application is accessing or requesting to access.

A feature of the GUI 1100 is the access mode selection panel 1112 that provides different access control options. The panel 1112 contains three interactive representations: a first access mode 1114 labeled “All apps enabled,” a second access mode 1116 labeled “Approval required,” and a third access mode 1118 labeled “All apps disabled.”

The first access mode 1114, “All apps enabled,” may allow all integration applications to access conference data without requiring individual approvals. This mode could be useful for conferences where all participants are trusted and the free flow of information to productivity tools is prioritized. In some implementations, selecting this mode may trigger a confirmation dialog to ensure the host understands the implications of enabling all apps.

The second access mode 1116, “Approval required,” may be the default setting in many implementations. This mode requires explicit approval from the host or a designated co-host before an integration application can access conference data. This balanced approach allows for careful consideration of each application's access request while still enabling the use of productivity-enhancing tools.

The third access mode 1118, “All apps disabled,” provides a high-security option where no integration applications are allowed to access conference data. This mode might be used for highly confidential meetings or in situations where compliance regulations require strict control over data access. In some implementations, selecting this mode may automatically disconnect any currently connected applications and prevent new connection requests.

In some implementations, the access mode selection panel 1112 may include additional modes or customizable options. For example, there could be a “Whitelist only” mode where only pre-approved applications are allowed access, or a “Time-limited access” mode where applications are granted access for a specified duration.

The GUI 1100 may also include visual indicators next to each access mode to show which mode is currently active. This could be in the form of a highlighted background, a checkmark, or a radio button selection. Additionally, hovering over or selecting an access mode may display a tooltip or information panel providing more details about the implications of each mode.

In some implementations, the GUI 1100 may include an audit log or history feature accessible from the access control portion 1104. This feature could allow hosts to review past access decisions, track which applications accessed data during the conference, and for how long. Such a feature could be valuable for compliance and security purposes.

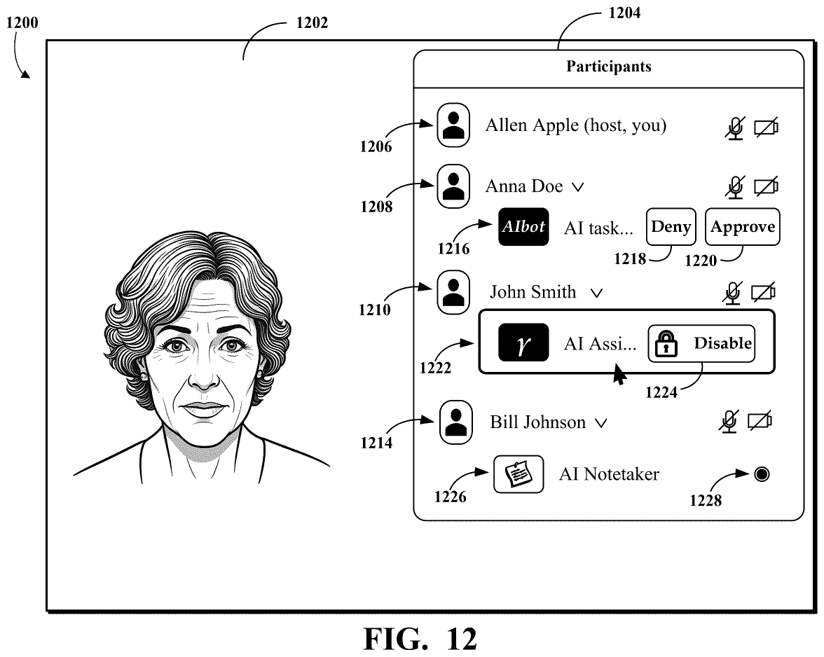

FIG. 12 illustrates a GUI 1200 associated with access controls for ingestion of multimedia during a communication session. The GUI 1200 may be displayed at a client device (e.g., the client 502 or the conferencing client 602) that is connected to a conference. Similar to the GUI 800, the GUI 900, the GUI 1000, and the GUI 1100, the GUI 1200 includes a video feed 1202 and a participant panel 1204. The video feed 1202 has a functionality similar to that of the video feed 802, the video feed 902, the video feed 1002, and the video feed 1102.

The participant panel 1204 displays various participant representations and associated application controls. This panel provides a unified view of both human participants and the integration applications they are using, allowing for efficient management of conference attendees and data access permissions.

The participant panel 1204 includes multiple participant representations 1206, including user representations 1208, 1210, and 1214. These representations may display the participant's name, profile picture, and current status (e.g., speaking, muted, video on/off). In some implementations, the participant representations may also indicate the participant's role in the conference, such as host, co-host, or attendee.

Associated with these user representations are application representations 1216, 1222, and 1226, which indicate applications being used by the respective participants. These application representations may be visually linked to their associated users, for example, by being nested under the user's name or connected by a line. This clear association helps hosts and participants understand who is responsible for each application accessing conference data.

The GUI 1200 provides interactive access controls 1218, 1220, and 1224 that allow for managing application permissions and access. These controls may take the form of buttons, toggles, or dropdown menus. For example, control 1218 might allow the host to approve or deny an application's access request, while control 1220 could enable or disable an already connected application.

A status indicator 1228 is displayed to show the current state or status of applications or user permissions. This indicator might use color coding (e.g., green for active, yellow for pending, red for denied) or icons to quickly convey the status of each application. In some implementations, the status indicator 1228 may be interactive, allowing users to click or hover over it for more detailed information or quick actions.

The participant panel 1204 may include additional features to enhance usability and control. For instance, it might offer a search function to quickly find specific participants or applications, especially useful in large conferences. It could also include sorting options to organize the list by participant name, application name, or access status.

In some implementations, the participant panel 1204 may support drag-and-drop functionality, allowing hosts to easily move applications between participants or to a “disabled” area to revoke access. This intuitive interface could streamline the process of managing application permissions in real-time during a conference.

The GUI 1200 may also include a feature to group participants and their associated applications. For example, participants from the same organization might be grouped together, or applications of the same type (e.g., all note-taking apps) could be collapsible under a single header. This organization could help manage permissions more efficiently in large or complex conferences

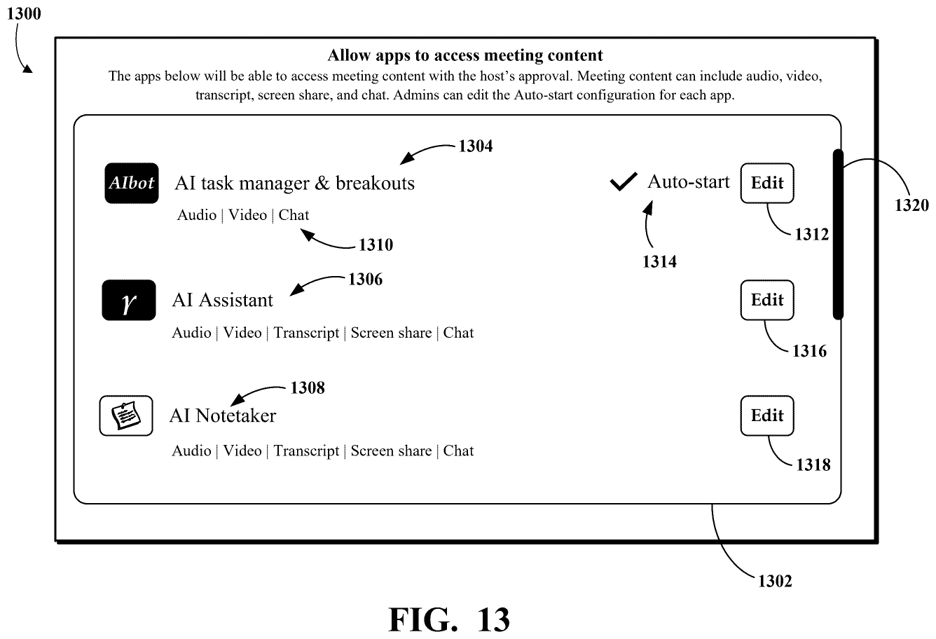

FIG. 13 illustrates a GUI 1300 associated with access controls for ingestion of multimedia during a communication session. The GUI 1300 may be displayed at a client device (e.g., the client 502 or the conferencing client 602) that is connected to a conference. The GUI 1300 focuses specifically on an access control panel 1302, which may be part of an administrative interface for managing integration applications across an organization.

The access control panel 1302 displays multiple application representations 1304, 1306, and 1308. Each of these representations provides detailed information about a specific integration application that may be used in conferences within the organization. This panel allows administrators to configure global settings for each application, ensuring consistent application behavior across all conferences.

Each application representation shows supported modalities 1310 indicating the types of meeting content the application can access, such as audio, video, transcript, screen share, and chat. This information helps administrators understand the potential data exposure for each application and make informed decisions about its use within the organization.

The access control panel 1302 includes interactive edit controls 1312, 1316, and 1318 associated with each application representation. These controls allow administrators to modify settings for individual applications. When selected, these edit controls may open a more detailed configuration panel for the specific application, where administrators can set permissions, configure auto-start behavior, or specify data retention policies.

An auto start indicator 1314 is displayed to show whether an application is configured to automatically begin accessing meeting content when a user joins a meeting. This feature can be particularly useful for applications that are considered essential for all meetings within an organization, such as compliance recording tools or automatic transcription services.

The GUI 1300 includes a scroll bar 1320 that enables navigation through additional application representations when the list extends beyond the visible area of the access control panel 1302. This feature ensures that the interface can accommodate a large number of integration applications without becoming cluttered or difficult to navigate.

In some implementations, the access control panel 1302 may include filtering and sorting options to help administrators manage a large number of applications. For example, there could be filters to show only applications with specific permissions, or sorting options to organize applications by name, frequency of use, or last modified date.

The GUI 1300 may also include a search function to quickly locate specific applications within the list. This could be particularly useful for organizations with a large number of approved integration applications.

In some implementations, the access control panel 1302 may support bulk actions, allowing administrators to modify settings for multiple applications simultaneously. For example, there could be an option to enable or disable auto-start for all applications of a certain type or from a specific vendor.

The GUI 1300 may include a feature to compare settings between different applications, helping administrators ensure consistency in their configuration. This could be implemented as a side-by-side view or a diff-style comparison highlighting the differences in permissions and settings between selected applications.

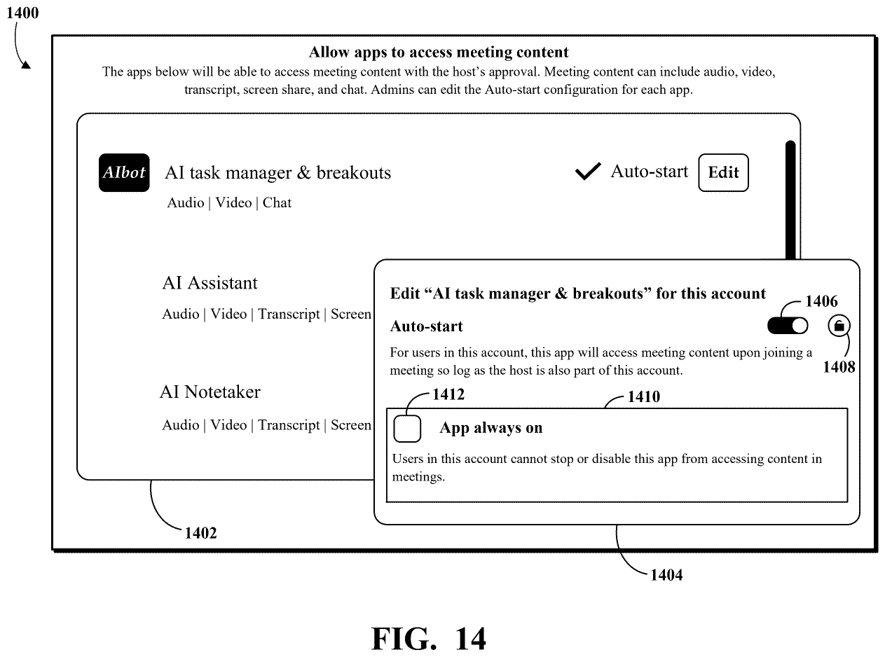

FIG. 14 illustrates a GUI 1400 associated with access controls for ingestion of multimedia during a communication session. The GUI 1400 may be displayed at a client device (e.g., the client 502 or the conferencing client 602) that is connected to a conference. Similar to the GUI 1300, the GUI 1400 includes an access control panel 1402. The GUI 1400 also includes an edit panel 1404, which may be, for example, a pop-up, a new window, a side bar, or a new tab, among other examples.

The access control panel 1402 provides a high-level view of application settings, similar to the panel in GUI 1300. It may include a list of applications with basic information such as name, supported modalities, and current status.

The edit panel 1404 offers a more detailed interface for configuring specific settings for a selected integration application. This panel may appear when an administrator clicks an “Edit” button associated with an application in the access control panel 1402.

Within the edit panel 1404, there is an interactive toggle 1406 for enabling auto-start functionality. When enabled, this feature allows the application to automatically connect and start accessing conference data when a user joins a meeting, without requiring explicit approval each time. This can be useful for applications that are considered essential or low-risk within an organization.

The edit panel 1404 also includes an access mode indicator 1408 that shows the current access status of the application. This indicator may display statuses such as “Enabled,” “Disabled,” or “Approval Required,” reflecting the current configuration for the application across the organization.

An interactive access control 1410 is provided in the edit panel 1404, allowing administrators to change the access mode for the application. This control may be implemented as a dropdown menu, a set of radio buttons, or another suitable interface element. It allows administrators to quickly switch between different access modes, such as always allowing the application, always blocking it, or requiring approval for each use.

The edit panel 1404 features an always on toggle 1412, which, when enabled, prevents users from disabling the integration application during meetings. This setting can be useful for applications that are required for compliance or security purposes, ensuring that they cannot be turned off by individual users during a conference.

In some implementations, the edit panel 1404 may include additional configuration options. For example, there could be fields to set data retention periods, specify which user roles are allowed to use the application, or configure notification settings for when the application accesses conference data.

The edit panel 1404 may also provide a testing interface, allowing administrators to simulate how the application will behave in different scenarios. This could include options to test the application's behavior when joining meetings with different settings or user roles.

In some implementations, the edit panel 1404 may include a changelog or version history, showing when and by whom changes were made to the application's settings. This feature can be valuable for auditing purposes and for tracking the evolution of application configurations over time.

The GUI 1400 may also include a feature to create and manage application profiles or templates. This would allow administrators to quickly apply a predefined set of settings to new applications or to update multiple applications with similar requirements simultaneously.

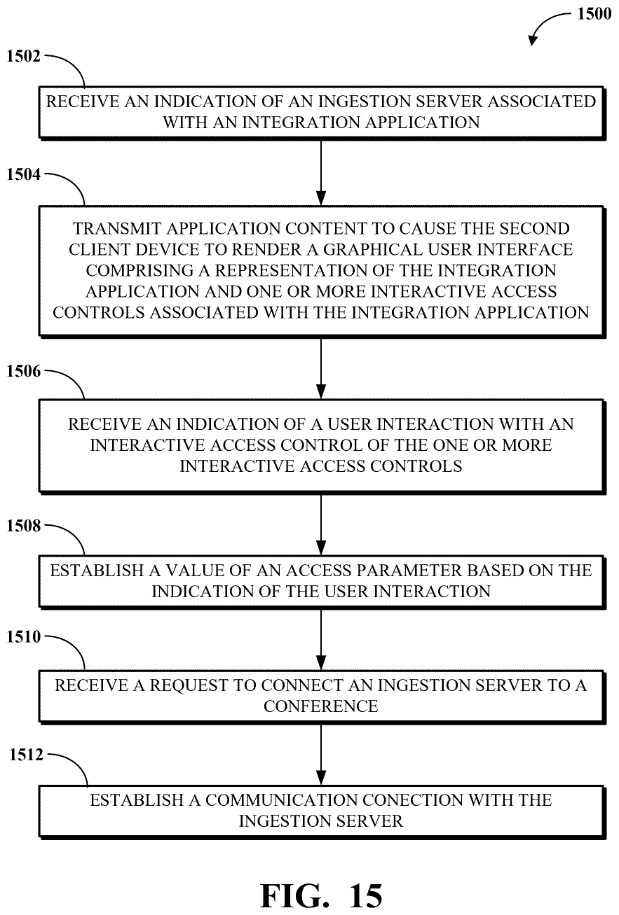

To further describe some implementations in greater detail, reference is next made to examples of techniques which may be performed by or using a system for ingesting multimedia data during a conference. FIG. 15 is a flowchart of an example of a technique 1500 for ingesting multimedia data during a conference. The technique 1500 can be executed using computing devices, such as the systems, hardware, and software described with respect to FIGS. 1-14. The technique 1500 can be performed, for example, by executing a machine-readable program or other computer-executable instructions, such as routines, instructions, programs, or other code. The steps, or operations, of the technique 1500, or another technique, method, process, or algorithm described in connection with the implementations disclosed herein can be implemented directly in hardware, firmware, software executed by hardware, circuitry, or a combination thereof.

For simplicity of explanation, the technique 1500 is depicted and described herein as a series of steps or operations. However, the steps or operations of the technique 1500 in accordance with this disclosure can occur in various orders and/or concurrently. Additionally, other steps or operations not presented and described herein may be used. Furthermore, not all illustrated steps or operations may be required to implement a technique in accordance with the disclosed subject matter.

FIG. 15 illustrates the technique 1500 for ingesting multimedia data during a conference. The technique 1500 may be performed by a conferencing server, which may be, for example, the conferencing server 506. The technique 1500 enables the efficient, secure, and scalable ingestion of multimedia data for analysis, storage, or downstream processing by external systems.

At 1502, the technique 1500 includes receiving an indication of an ingestion server associated with an integration application. For example, a conferencing server (e.g., the conferencing server 506 shown in FIG. 5) may receive, from a first client device, an indication of an ingestion server associated with an integration application. In some implementations, the indication may include an identifier of the ingestion server, such as an IP address, a URL, or a unique identifier assigned by the conferencing system. The integration application may be, for example, a note-taking application, a transcription service, or an AI-powered meeting assistant.

At 1504, the technique 1500 includes transmitting application content to cause a second client device to render a graphical user interface comprising a representation of the integration application and one or more interactive access controls associated with the integration application. For example, the conferencing server may transmit, to a second client device, application content to cause the second client device to render, on a display device of the second client device, a graphical user interface comprising a representation of the integration application and one or more interactive access controls associated with the integration application. In some implementations, the graphical user interface may be similar to the GUI 800 shown in FIG. 8, which includes a control panel 804 with a representation 806 of an integration application and interactive access controls 812 and 814.

At 1506, the technique 1500 includes receiving an indication of a user interaction with an interactive access control of the one or more interactive access controls. For example, the conferencing server may receive, from the second client device, an indication of a user interaction with an interactive access control of the one or more interactive access controls, wherein the interactive access control corresponds to an access parameter associated with the integration application. In some implementations, the interactive access control may be an approve button, a deny button, or a dropdown menu for selecting an access mode, as shown in the GUI 1000 of FIG. 10.

At 1508, the technique 1500 includes establishing a value of the access parameter based on the indication of the user interaction. For example, the conferencing server may establish a value of the access parameter based on the indication of the user interaction. In some implementations, the value of the access parameter may be indicative of an enabled access mode, a disabled access mode, or an approval required access mode, as shown in the access mode selection panel 1112 of FIG. 11.

At 1510, the technique 1500 includes receiving a request to connect the ingestion server to a conference to which the first client device is connected. For example, the conferencing server may receive, from the second client device, a request to connect the ingestion server to a conference to which the first client device is connected, the request comprising an identifier of the ingestion server. In some implementations, the request may be generated automatically based on the established value of the access parameter, or it may require additional user confirmation.

At 1512, the technique 1500 includes establishing a communication connection with the ingestion server based on the value of the access parameter. For example, the conferencing server may establish, based on the value of the access parameter, a communication connection with the ingestion server. In some implementations, this may involve setting up a WebSocket connection, as described in the data flow diagram 700 of FIG. 7.

In some implementations, the technique 1500 may further include transmitting, to a third client device, notification content to cause the third client device to render a notification pane comprising a selectable link that, when selected, causes the third client device to render a list of connected integration applications. This notification pane may be similar to the notification panel 904 shown in FIG. 9, which includes a hyperlink 908 for accessing more information about connected applications.

In some implementations, the graphical user interface rendered on the second client device may comprise an active application notification panel comprising at least one additional representation of at least one additional integration application. The technique 1500 may include receiving an indication of a user interaction with the at least one additional representation and transmitting application detail content to cause the second client device to render information about the at least one additional integration application. This functionality may be similar to the access control portion 1004 shown in FIG. 10, which displays multiple application representations.

In some implementations, the technique 1500 may include transmitting additional application content to cause the second client device to render an additional graphical user interface comprising an additional interactive access control. The technique may then include receiving an indication of a user interaction with the additional interactive access control, establishing an additional value of the access parameter based on the indication of the user interaction, and potentially disabling the established communication connection with the ingestion server if the additional value of the access parameter is indicative of a disabled access mode.

In some implementations, the graphical user interface may comprise a participant panel comprising a set of participant representations, as shown in the participant panel 1204 of FIG. 12. The technique 1500 may include receiving an indication of an additional ingestion server associated with an additional integration application, transmitting additional application content to cause the second client device to render a representation of the additional integration application and additional interactive access controls, and potentially establishing an additional communication connection with the additional ingestion server based on user interactions with these controls.

In some implementations, the technique 1500 may include determining a participant identifier associated with the second client device and determining a participant type associated with the participant identifier. The one or more interactive access controls presented in the graphical user interface may be based on this participant type, allowing for role-based access control within the conferencing system.

In some implementations, the technique 1500 may include determining a set of media types being consumed by the ingestion server and causing the second client device to render an indication of a set of supported modalities based on these media types. This information may be displayed similarly to the supported modalities 810 shown in FIG. 8, providing transparency about the types of data the integration application can access.

In some implementations, the graphical user interface may comprise an administrative settings panel with an access parameter interface, as shown in the GUI 1300 of FIG. 13. The interactive access control may include an edit button that, when selected, causes an edit panel to be rendered, displaying a plurality of values of the access parameter. This edit panel may be similar to the edit panel 1404 shown in FIG. 14, which includes options for configuring auto-start functionality and setting an “always on” mode.

In some implementations, the value of the access parameter established in step 1508 may be indicative of an automatic connection mode. In such cases, the communication connection with the ingestion server may be established automatically when the integration application is added to the conference, without requiring additional user approval for each instance.

In some implementations, the value of the access parameter may be indicative of an “always on” mode, in which participants are unable to disable the integration application during the conference. This mode may be useful for applications required for compliance or security purposes, ensuring that they remain active throughout the entire conference duration.

By following the technique 1500, the conferencing system can provide a flexible and secure method for managing the connection of integration applications to conferences, balancing the need for productivity-enhancing tools with the requirements for data privacy and user control.

According to an aspect of the disclosure, there is provided a method. The method includes receiving, by a conferencing server and from a first client device, an indication of an ingestion server associated with an integration application. The method also includes transmitting, by the conferencing server and to a second client device, application content to cause the second client device to render, on a display device of the second client device, a graphical user interface comprising a representation of the integration application and one or more interactive access controls associated with the integration application. The method further includes receiving, by the conferencing server and from the second client device, an indication of a user interaction with an interactive access control of the one or more interactive access controls, where the interactive access control corresponds to an access parameter associated with the integration application. The method also includes establishing a value of the access parameter based on the indication of the user interaction. Additionally, the method includes receiving, by the conferencing server and from the second client device, a request to connect the ingestion server to a conference to which the first client device is connected, where the request comprises an identifier of the ingestion server. Finally, the method includes establishing, by the conferencing server and based on the value of the access parameter, a communication connection with the ingestion server. This method has the technical effect of enabling secure and controlled access to conference data by third-party applications, improving data privacy and user control in conferencing systems. Additionally, this method provides the technical advantage of streamlining the integration of AI/ML applications with conferencing platforms while maintaining granular access controls.

In embodiments, the method can include transmitting, to a third client device, notification content to cause the third client device to render, on the display device of the third client device, a notification pane comprising a selectable link that, when selected, causes the third client device to render, on the display device of the third client device, a list of connected integration applications. This feature has the technical effect of enhancing transparency by providing real-time visibility of connected applications to all conference participants. Additionally, this feature improves user awareness and control over data access during conferences.

In embodiments, the graphical user interface can comprise an active application notification panel comprising at least one additional representation of at least one additional integration application. The method can include receiving an indication of a user interaction with the at least one additional representation of the at least one additional integration application. The method can also include transmitting, to the second client device and based on the user interaction with the at least one additional representation, application detail content to cause the second client device to render, on the display device of the second client device, information about the at least one additional integration application. This feature has the technical effect of providing a centralized interface for managing multiple integration applications, improving user efficiency in controlling data access. Additionally, this feature enhances the user experience by offering detailed information about connected applications on-demand.

In embodiments, the method can include transmitting, to the second client device, additional application content to cause the second client device to render, on the display device of the second client device, an additional graphical user interface comprising an additional interactive access control. The method can include receiving, from the second client device, an indication of a user interaction with the additional interactive access control. The method can also include establishing an additional value of the access parameter based on the indication of the user interaction with the additional interactive access control, where the additional value of the access parameter is indicative of a disabled access mode. The method can further include disabling the established communication connection with the ingestion server based on the additional value of the access parameter being indicative of the disabled access mode. This feature has the technical effect of allowing real-time modification of access permissions, enhancing dynamic control over data security during ongoing conferences. Additionally, this feature provides the advantage of immediate revocation of access for integration applications when needed.

In embodiments, the graphical user interface can comprise a participant panel comprising a set of participant representations. The method can include receiving, from a third client device, an indication of an additional ingestion server associated with an additional integration application. The method can include transmitting, to the second client device and based on the indication of the additional ingestion server, additional application content to cause the second client device to render, in the participant panel, a representation of the additional integration application and one or more additional interactive access controls associated with the additional integration application. The method can include receiving, from the second client device, an indication of a user interaction with an additional interactive access control of the one or more additional interactive access controls, where the additional interactive access control corresponds to an access parameter associated with the additional integration application. The method can include establishing an additional value of the access parameter based on the indication of the user interaction with the additional interactive access control, where the additional value of the access parameter is indicative of an approval of the request to connect the additional ingestion server to the conference. The method can include establishing, based on the additional value of the access parameter, an additional communication connection with the additional ingestion server. This feature has the technical effect of enabling scalable management of multiple integration applications within a single interface, improving system efficiency. Additionally, this feature provides the advantage of streamlined approval processes for multiple applications, enhancing user productivity.

In embodiments, the method can include determining a participant identifier associated with the second client device. The method can also include determining a participant type associated with the participant identifier, where the one or more interactive access controls are based on the participant type. This feature has the technical effect of implementing role-based access control, enhancing security and permissions management in the conferencing system. Additionally, this feature provides the advantage of customized user interfaces based on participant roles, improving user experience and system functionality.

In embodiments, the method can include determining a set of media types being consumed by the ingestion server, where the application content further causes the second client device to render, in the graphical user interface, an indication of a set of supported modalities based on the set of media types. This feature has the technical effect of providing transparency about the types of data being accessed by integration applications, enhancing user trust and data privacy awareness. Additionally, this feature offers the advantage of allowing users to make informed decisions about granting access based on specific data types.

According to an aspect of the disclosure, there is provided a non-transitory computer readable medium storing instructions operable to cause one or more processors to perform operations. The operations include receiving, by a conferencing server and from a first client device, an indication of an ingestion server associated with an integration application. The operations also include transmitting, by the conferencing server and to a second client device, application content to cause the second client device to render, on a display device of the second client device, a graphical user interface comprising a representation of the integration application and one or more interactive access controls associated with the integration application. The operations further include receiving, by the conferencing server and from the second client device, an indication of a user interaction with an interactive access control of the one or more interactive access controls, where the interactive access control corresponds to an access parameter associated with the integration application. The operations also include establishing a value of the access parameter based on the indication of the user interaction. Additionally, the operations include receiving, by the conferencing server and from the second client device, a request to connect the ingestion server to a conference to which the first client device is connected, where the request comprises an identifier of the ingestion server. Finally, the operations include establishing, by the conferencing server and based on the value of the access parameter, a communication connection with the ingestion server. This non-transitory computer readable medium has the technical effect of enabling secure and controlled access to conference data by third-party applications through software implementation, improving system flexibility and scalability. Additionally, this non-transitory computer readable medium provides the technical advantage of facilitating easy deployment and updates of the access control system across multiple devices or servers.

In embodiments, the interactive access control can comprise an interactive access mode control configured to cause, in response to an interaction with the interactive access mode control, a selection of an access mode from a set of access modes. This feature has the technical effect of providing a user-friendly interface for managing complex access control settings, improving system usability. Additionally, this feature offers the advantage of quick and intuitive access mode changes, enhancing user control over data privacy.

In embodiments, the interactive access control can comprise an interactive access mode control configured to cause, in response to an interaction with the interactive access mode control, a selection of an access mode from a set of access modes, where the set of access modes comprises an enabled access mode, a disabled access mode, and an approval required access mode. This feature has the technical effect of offering granular control over application access, enhancing system security and flexibility. Additionally, this feature provides the advantage of accommodating various security requirements and user preferences within a single interface.

In embodiments, the graphical user interface can comprise a request alert panel, and the one or more interactive access controls can comprise a deny button and an approve button. This feature has the technical effect of providing immediate visual feedback for access requests, improving system responsiveness and user awareness. Additionally, this feature offers the advantage of quick decision-making capabilities for users managing access requests.

In embodiments, the graphical user interface can comprise a request alert panel, and the representation of the integration application can comprise a selectable control that, when selected, causes the second client device to render, on the display device of the second client device, an additional interactive access control associated with the integration application. This feature has the technical effect of providing on-demand access to detailed controls, optimizing screen space usage while maintaining comprehensive management capabilities. Additionally, this feature offers the advantage of a layered interface design, allowing for both quick overviews and detailed control when needed.

In embodiments, the graphical user interface can comprise a request alert panel indicative of a name of the integration application and a name of a participant associated with the integration application, and the one or more interactive access controls can comprise a deny button and an approve button. This feature has the technical effect of providing context-rich information for access decisions, enhancing security by clearly associating applications with participants. Additionally, this feature offers the advantage of streamlined decision-making by presenting all relevant information in a single view.

In embodiments, the graphical user interface can comprise a participant list that displays a set of participant representations, where the representation of the integration application is associated with a participant representation of the set of participant representations. This feature has the technical effect of visually linking applications to participants, improving system transparency and user understanding of data access patterns. Additionally, this feature provides the advantage of intuitive management of application access within the familiar context of a participant list.

In embodiments, the graphical user interface can comprise an active application notification panel comprising at least one additional representation of at least one additional integration application. This feature has the technical effect of providing a comprehensive overview of all active applications, enhancing system monitoring capabilities. Additionally, this feature offers the advantage of centralized management for multiple applications, improving user efficiency in controlling data access.

According to an aspect of the disclosure, there is provided a system. The system includes a memory subsystem storing instructions and processing circuitry configured to execute the instructions to cause the system to perform operations. The operations include receiving, from a first client device, an indication of an ingestion server associated with an integration application. The operations also include transmitting, to a second client device, application content to cause the second client device to render, on a display device of the second client device, a graphical user interface comprising a representation of the integration application and one or more interactive access controls associated with the integration application. The operations further include receiving, from the second client device, an indication of a user interaction with an interactive access control of the one or more interactive access controls, where the interactive access control corresponds to an access parameter associated with the integration application. The operations also include establishing a value of the access parameter based on the indication of the user interaction. Additionally, the operations include receiving, from the second client device, a request to connect the ingestion server to a conference to which the first client device is connected, where the request comprises an identifier of the ingestion server. Finally, the operations include establishing, based on the value of the access parameter, a communication connection with the ingestion server. This system has the technical effect of providing a hardware-software combination for implementing secure and controlled access to conference data, offering improved performance and reliability. Additionally, this system provides the technical advantage of a dedicated architecture for managing integration applications, potentially improving processing speed and reducing latency in access control operations.

In embodiments, the value of the access parameter can be indicative of an enabled access mode. The establishing the communication connection with the ingestion server can be further based on the value of the access parameter being indicative of the enabled access mode. This feature has the technical effect of implementing a streamlined connection process for approved applications, reducing system overhead for repeated access requests. Additionally, this feature provides the advantage of faster integration of approved applications into the conference environment.

In embodiments, the graphical user interface can comprise an administrative settings panel comprising an access parameter interface, and the interactive access control can comprise an edit button that, when selected, causes an edit panel to be rendered, where the edit panel displays a plurality of values of the access parameter. This feature has the technical effect of providing a centralized interface for detailed access control configuration, enhancing system manageability. Additionally, this feature offers the advantage of fine-grained control over access parameters, allowing administrators to tailor the system to specific security requirements.

In embodiments, the graphical user interface can comprise an administrative settings panel comprising an access parameter interface. The interactive access control can comprise an edit button that, when selected, causes an edit panel to be rendered, where the edit panel comprises an adjustable input element configured to set a value of the access parameter, where the value of the access parameter is indicative of an automatic connection mode. The communication connection established with the ingestion server can be further established based on the value of the access parameter being indicative of the automatic connection mode. This feature has the technical effect of enabling automated connection processes for trusted applications, reducing manual intervention and improving system efficiency. Additionally, this feature provides the advantage of streamlined integration for frequently used or essential applications.

In embodiments, the graphical user interface can comprise an administrative settings panel comprising an access parameter interface. The interactive access control can comprise an edit button that, when selected, causes an edit panel to be rendered, where the edit panel comprises an adjustable input element configured to set a value of the access parameter. The value of the access parameter can be indicative of an always on mode, the always on mode comprising a mode in which participants are unable to disable the integration application. The established communication connection with the ingestion server can be further based on the value of the access parameter being indicative of the always on mode. This feature has the technical effect of ensuring continuous data access for critical applications, enhancing reliability for essential integrations such as compliance monitoring. Additionally, this feature provides the advantage of maintaining consistent application behavior across all conferences, reducing the risk of accidental disconnection of important services.

In one implementation, the disclosed system for ingesting multimedia data during a conference is utilized in a healthcare setting. A doctor, using the first client device, initiates a telemedicine consultation with a patient. The doctor activates an AI-powered diagnostic assistant, which is an integration application hosted on an ingestion server. The conferencing server transmits application content to the doctor's device, rendering a graphical user interface with a representation of the diagnostic assistant and interactive access controls. The doctor interacts with these controls to grant the AI assistant access to the audio and video streams of the consultation. Once approved, the conferencing server establishes a communication connection with the ingestion server, allowing the AI assistant to analyze the patient's symptoms in real-time and provide diagnostic suggestions to the doctor.

Another implementation focuses on financial compliance monitoring during corporate meetings. A compliance officer, using the second client device, joins a quarterly earnings call. The officer activates a data loss prevention (DLP) application, which is designed to monitor and flag potential disclosure of sensitive financial information. The graphical user interface displays the DLP application with an “always on” access parameter, ensuring continuous monitoring throughout the call. The conferencing server establishes a persistent communication connection with the ingestion server hosting the DLP application. During the call, if any participant mentions confidential financial data, the DLP application immediately alerts the compliance officer, allowing for swift intervention to prevent unauthorized disclosures.

In an alternative implementation, the system can be adapted for use in educational settings with varying levels of data access based on participant roles. For instance, in a virtual classroom, the teacher's client device may have administrative settings that allow automatic approval of certain integration applications, such as attendance trackers or engagement analyzers. Student devices, however, may have more restricted access controls. The graphical user interface for student devices might display a simplified set of interactive access controls, allowing them to approve or deny access to their individual data streams for specific educational tools. This role-based access control ensures that sensitive student data is protected while still enabling the use of beneficial educational technologies.

The integration application access control features and graphical user interfaces described herein provide a versatile and robust framework for managing third-party application access to conference data across various domains. These features may offer significant advantages in terms of security, user control, and system efficiency. The granular access controls, coupled with intuitive graphical interfaces, may allow conference hosts and participants to make informed decisions about data sharing in real-time. This approach may be broadly applicable across industries such as healthcare, finance, education, and beyond, where the need for secure and controlled data access during virtual meetings is paramount. The system's flexibility in handling different access modes, from manual approvals to automatic connections and always-on settings, may accommodate diverse use cases and security requirements. Additionally, the role-based access controls and administrative settings may enable organizations to implement consistent data governance policies while still allowing for customization based on specific meeting needs or participant roles. By providing a comprehensive yet user-friendly system for managing integration applications, these features may enhance the overall conferencing experience, foster innovation in AI and machine learning applications, and help organizations balance the benefits of data-driven insights with the imperative of data protection and privacy.

As used herein, unless explicitly stated otherwise, any term specified in the singular may include its plural version. For example, “a computer that stores data and runs software,” may include a single computer that stores data and runs software or two computers - a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

As used herein, the term “and/or” encompasses its plain and ordinary meaning and may refer to either an intersection or a union of sets of data. In a first example, the phrase “A and/or B” encompasses the intersection of A and B. In a second example, the phrase “A and/or B” encompasses the union of A and B.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving, by a conferencing server and from a first client device, an indication of an ingestion server associated with an integration application;
transmitting, by the conferencing server and to a second client device, application content to cause the second client device to render, on a display device of the second client device, a graphical user interface comprising a representation of the integration application and one or more interactive access controls associated with the integration application;
receiving, by the conferencing server and from the second client device, an indication of a user interaction with an interactive access control of the one or more interactive access controls, wherein the interactive access control corresponds to an access parameter associated with the integration application;
establishing a value of the access parameter based on the indication of the user interaction;
receiving, by the conferencing server and from the second client device, a request to connect the ingestion server to a conference to which the first client device is connected, the request comprising an identifier of the ingestion server; and
establishing, by the conferencing server and based on the value of the access parameter, a communication connection with the ingestion server.

2. The method of claim 1, further comprising:
transmitting, to a third client device, notification content to cause the third client device to render, on the display device of the third client device, a notification pane comprising a selectable link that, when selected, causes the third client device to render, on the display device of the third client device, a list of connected integration applications.

3. The method of claim 1, wherein the graphical user interface comprises an active application notification panel comprising at least one additional representation of at least one additional integration application; and wherein the method further comprises:
receiving an indication of a user interaction with the at least one additional representation of the at least one additional integration application; and
transmitting, to the second client device and based on the user interaction with the at least one additional representation, application detail content to cause the second client device to render, on the display device of the second client device, information about the at least one additional integration application.

4. The method of claim 1, further comprising:
transmitting, to the second client device, additional application content to cause the second client device to render, on the display device of the second client device, an additional graphical user interface comprising an additional interactive access control;
receiving, from the second client device, an indication of a user interaction with the additional interactive access control;
establishing an additional value of the access parameter based on the indication of the user interaction with the additional interactive access control, wherein the additional value of the access parameter is indicative of a disabled access mode; and
disabling the established communication connection with the ingestion server based on the additional value of the access parameter being indicative of the disabled access mode.

5. The method of claim 1, wherein the graphical user interface comprises a participant panel comprising a set of participant representations; and wherein the method further comprises:
receiving, from a third client device, an indication of an additional ingestion server associated with an additional integration application;
transmitting, to the second client device and based on the indication of the additional ingestion server, additional application content to cause the second client device to render, in the participant panel, a representation of the additional integration application and one or more additional interactive access controls associated with the additional integration application;
receiving, from the second client device, an indication of a user interaction with an additional interactive access control of the one or more additional interactive access controls, wherein the additional interactive access control corresponds to an access parameter associated with the additional integration application;
establishing an additional value of the access parameter based on the indication of the user interaction with the additional interactive access control, wherein the additional value of the access parameter is indicative of an approval of the request to connect the additional ingestion server to the conference; and
establishing, based on the additional value of the access parameter, an additional communication connection with the additional ingestion server.

6. The method of claim 1, further comprising:
determining a participant identifier associated with the second client device; and
determining a participant type associated with the participant identifier, wherein the one or more interactive access controls are based on the participant type.

7. The method of claim 1, further comprising:
determining a set of media types being consumed by the ingestion server, wherein the application content further causes the second client device to render, in the graphical user interface, an indication of a set of supported modalities based on the set of media types.

8. A non-transitory computer readable medium storing instructions operable to cause one or more processors to perform operations comprising:
receiving, by a conferencing server and from a first client device, an indication of an ingestion server associated with an integration application;
transmitting, by the conferencing server and to a second client device, application content to cause the second client device to render, on a display device of the second client device, a graphical user interface comprising a representation of the integration application and one or more interactive access controls associated with the integration application;
receiving, by the conferencing server and from the second client device, an indication of a user interaction with an interactive access control of the one or more interactive access controls, wherein the interactive access control corresponds to an access parameter associated with the integration application;
establishing a value of the access parameter based on the indication of the user interaction;
receiving, by the conferencing server and from the second client device, a request to connect the ingestion server to a conference to which the first client device is connected, the request comprising an identifier of the ingestion server; and
establishing, by the conferencing server and based on the value of the access parameter, a communication connection with the ingestion server.

9. The non-transitory computer readable medium of claim 8, wherein the interactive access control comprises an interactive access mode control configured to cause, in response to an interaction with the interactive access mode control, a selection of an access mode from a set of access modes.

10. The non-transitory computer readable medium of claim 8, wherein the interactive access control comprises an interactive access mode control configured to cause, in response to an interaction with the interactive access mode control, a selection of an access mode from a set of access modes, the set of access modes comprising an enabled access mode, a disabled access mode, and an approval required access mode.

11. The non-transitory computer readable medium of claim 8, wherein the graphical user interface comprises a request alert panel, and wherein the one or more interactive access controls comprise a deny button and an approve button.

12. The non-transitory computer readable medium of claim 8, wherein the graphical user interface comprises a request alert panel, and wherein the representation of the integration application comprises a selectable control that, when selected, causes the second client device to render, on the display device of the second client device, an additional interactive access control associated with the integration application.

13. The non-transitory computer readable medium of claim 8, wherein the graphical user interface comprises a request alert panel indicative of a name of the integration application and a name of a participant associated with the integration application, and wherein the one or more interactive access controls comprise a deny button and an approve button.

14. The non-transitory computer readable medium of claim 8, wherein the graphical user interface comprises a participant list that displays a set of participant representations, wherein the representation of the integration application is associated with a participant representation of the set of participant representations.

15. The non-transitory computer readable medium of claim 8, wherein the graphical user interface comprises an active application notification panel comprising at least one additional representation of at least one additional integration application.

16. A system, comprising:
a memory subsystem storing instructions; and
processing circuitry configured to execute the instructions to cause the system to:
receive, from a first client device, an indication of an ingestion server associated with an integration application;
transmit, to a second client device, application content to cause the second client device to render, on a display device of the second client device, a graphical user interface comprising a representation of the integration application and one or more interactive access controls associated with the integration application;
receive, from the second client device, an indication of a user interaction with an interactive access control of the one or more interactive access controls, wherein the interactive access control corresponds to an access parameter associated with the integration application;
establish a value of the access parameter based on the indication of the user interaction;
receive, from the second client device, a request to connect the ingestion server to a conference to which the first client device is connected, the request comprising an identifier of the ingestion server; and
establish, based on the value of the access parameter, a communication connection with the ingestion server.

17. The system of claim 16, wherein the value of the access parameter is indicative of an enabled access mode; and wherein the establishing the communication connection with the ingestion server is further based on the value of the access parameter being indicative of the enabled access mode.

18. The system of claim 16, wherein the graphical user interface comprises an administrative settings panel comprising an access parameter interface, and wherein the interactive access control comprises an edit button that, when selected, causes an edit panel to be rendered, wherein the edit panel displays a plurality of values of the access parameter.

19. The system of claim 16, wherein the graphical user interface comprises an administrative settings panel comprising an access parameter interface; wherein the interactive access control comprises an edit button that, when selected, causes an edit panel to be rendered, wherein the edit panel comprises an adjustable input element configured to set a value of the access parameter, wherein the value of the access parameter is indicative of an automatic connection mode; and wherein the communication connection established with the ingestion server is further established based on the value of the access parameter being indicative of the automatic connection mode.

20. The system of claim 16, wherein the graphical user interface comprises an administrative settings panel comprising an access parameter interface; wherein the interactive access control comprises an edit button that, when selected, causes an edit panel to be rendered, wherein the edit panel comprises an adjustable input element configured to set a value of the access parameter; wherein the value of the access parameter is indicative of an always on mode, the always on mode comprising a mode in which participants are unable to disable the integration application; and wherein the established communication connection with the ingestion server is further based on the value of the access parameter being indicative of the always on mode.
